(19) United States
(12) Patent Application Publication
(10) Pub. No.: US 2016/0284016 A1
(43) Pub. Date: Sep. 29, 2016

(54) HEALTH AND FITNESS NETWORKING AND MANAGEMENT

(71) Applicant: Live Ever Fit, LLC, Houston, TX (US)

(72) Inventor: Rory Caton, Houston, TX (US)

(21) Appl. No.: 15/079,000

(22) Filed: Mar. 23, 2016

Related U.S. Application Data
(60) Provisional application No. 62/137,052, filed on Mar. 23, 2015.

(51) Int. Cl. G06Q 30/06; G06Q 50/00; G06F 17/30

(52) U.S. Cl. CPC G06Q 30/0641; G06F 17/30864; G06Q 50/01

(57) ABSTRACT

The system and method provide a platform for users to gain access to professional trainers and nutritionists as well as receive meaningful guidance and feedback. It includes but is not limited to a variety of interactive features, online courses, live streaming videos, learning sessions, fitness articles, rankings and reviews, fitness trends, nutritional guidance and healthy meal delivery, inspiration of trainers and users with a sense of camaraderie, progress and achievement, through a constant interaction with no geographical boundaries.

### RELATED APPLICATION

This application claims priority to U.S. Provisional Application No. 62/137,052 filed Mar. 23, 2015.

### FIELD

The disclosure relates generally to health and fitness. The disclosure relates specifically to a platform for networking of individuals interested in health and fitness.

### BACKGROUND

Fitness professionals are limited by time, hourly wage, and location. Fitness club users are limited by a lack of variety of classes, location, and the price of membership. Fitness clubs are limited by location and the price of membership. A solution is needed to provide greater interaction between these groups.

### SUMMARY

An embodiment of the disclosure is a member database comprising users comprising more than one selected from the group consisting of trainers, instructors, nutritionists, gyms and promotors wherein each member has a profile and is capable of interacting with other members. In an embodiment, wherein there is a section for clients. In an embodiment, wherein there is a contact section. In an embodiment, wherein there is a client section. In an embodiment, wherein there is a client groups section. In an embodiment, wherein there is a trainer requests section. In an embodiment, wherein there is a section for trainers. In an embodiment, wherein there is a tasks section. In an embodiment, wherein there is a workouts section. In an embodiment, wherein there is a calendar section. In an embodiment, wherein there is a messages section. In an embodiment, wherein there is a files section. In an embodiment, wherein there is a reports section. In an embodiment, wherein there is a settings section. In an embodiment, wherein there is a guided tour section. In an embodiment, wherein there is a frequently asked questions section. In an embodiment, wherein there is a contact section.

An embodiment of the disclosure is a system of a digital database comprising the ability for users to search for at least one selected from the group consisting of products and services; and receive at least one selected from products and services.

An embodiment of the disclosure is a method for providing information to users of a health and fitness social networking system, the method comprising: maintaining a profile for one or more users; allowing searching of the profile; allowing communication between one or more users; allowing the receipt of one or more communications from one or more users by one or more users; and allowing one or more users to provide at least one selected from fitness training and nutrition planning for one or more users for a fee; wherein the system receives a portion of the fee. In an embodiment, the method further comprises recording of information regarding one or more users by one or more users.

The foregoing has outlined rather broadly the features of the present disclosure in order that the detailed description that follows may be better understood. Additional features and advantages of the disclosure will be described hereinafter, which form the subject of the claims.

### BRIEF DESCRIPTION OF THE DRAWINGS

In order that the manner in which the above-recited and other enhancements and objects of the disclosure are obtained, a more particular description of the disclosure briefly described above will be rendered by reference to specific embodiments thereof which are illustrated in the appended drawings. Understanding that these drawings depict only typical embodiments of the disclosure and are therefore not to be considered limiting of its scope, the disclosure will be described with additional specificity and detail through the use of the accompanying drawings in which:

FIG. 1 depicts a landing page layout and notes.

FIG. 2 depicts a social page.

FIG. 3 depicts a “Find a Pro” page.

FIG. 4 depicts a “Professional Workout Videos” page.

FIG. 5 depicts a “Mega Fitness Shop” page.

FIG. 6 depicts a General User Sign-Up Auto email. NOTE: In the auto email, the user is given 4 options, to be added to the Professional map as a trainer, nutritionist, instructor, or promoter. Once the user selects one of the 4 options provided in the General Auto-Responder, the corresponding/appropriate Auto-Responder is sent to the user.

FIG. 7 depicts a Trainer Auto-Responder. NOTE: There can be a “Free Trainer Search Add-On”.

FIG. 8 depicts a Nutritionist Auto-Responder. NOTE: There can be a “Free Nutritionist Search Add-On”.

FIG. 9 depicts an Instructor Auto-Responder. NOTE: There can be a “Free Instructor Search Add-On”.

FIG. 10 depicts Promoter Auto-Responder. NOTE: There can be a “Free Promoter Search Add-On”.

FIG. 11 depicts a logged in home screenshot and short function description notes.

FIG. 12 depicts a logged in home screenshot with “dashboard” “selected” and short function description notes.

FIG. 13 depicts a “Pro-Round-Up Incentive Campaign/Email” specific to trainers, nutritionists, and instructors currently on the Network/Map of Pros. NOTE: Adding more “Professionals” to the Network prior to sending this email to the general existing users. Run “Pro Round-Up Incentive Campaign/Email specific to the “general user” currently on the Network/Map of Pros. This incentivizes the “general users” currently on the site to also add “professionals”.

FIG. 14 depicts a logged in Find a Pro Screenshot and short function description notes.

FIG. 15 depicts a logged in Workouts Page Screenshot and short function description notes.

FIG. 16 depicts a logged in Workouts Page Screenshot and short function description notes with “Video Commenting and Sharing”.

FIG. 17 depicts a logged in Group Page Example Screenshot and short function description notes.

FIG. 18 depicts a Shop Home Page Screenshot and short function description notes.

FIG. 19 depicts a Profile Page Screenshot and short function description notes.

FIG. 20 depicts a page with the options to “Sign In”, “Sign Up”, or “Learn More”.

FIG. 21 depicts a page including a dashboard.

FIG. 22 depicts the map.

FIG. 23 depicts muted color and back screen on the mobile platform.

FIG. 24 depicts Home, Shop, and Find a Pro on the mobile platform.

FIG. 25 depicts the dashboard menu on the mobile platform.

FIG. 26 depicts social media marketing.

FIG. 27 depicts social media marketing.

FIG. 28 depicts social media marketing.

FIG. 29 depicts social media marketing.

FIG. 30 depicts social media marketing.

FIG. 31 depicts social media marketing.

FIG. 32 depicts social media marketing.

FIG. 33 depicts social media marketing.

FIG. 34 depicts social media marketing for food.

FIG. 35 depicts social media marketing for food.

FIG. 36 depicts social media marketing.

FIG. 37 depicts social media marketing.

FIG. 38 depicts social media marketing.

FIG. 39 depicts social media marketing.

FIG. 40 depicts social media marketing for plyometrics.

FIG. 41 depicts social media marketing for advanced.

FIG. 42 depicts social media marketing for baseball.

FIG. 43 depicts social media marketing for basketball.

FIG. 44 depicts social media marketing for beginners.

FIG. 45 depicts social media marketing for calisthenics.

FIG. 46 depicts social media marketing for circuits.

FIG. 47 depicts social media marketing for crossfit.

FIG. 48 depicts social media marketing for cycling.

FIG. 49 depicts social media marketing for football.

FIG. 50 depicts social media marketing for golf.

FIG. 51 depicts social media marketing for high intensity interval training.

FIG. 52 depicts social media marketing for intermediate.

FIG. 53 depicts social media marketing for kettlebell.

FIG. 54 depicts social media marketing for kickboxing.

FIG. 55 depicts social media marketing for nutrition.

FIG. 56 depicts social media marketing for yoga.

FIG. 57 depicts social media marketing skiing.

FIG. 58 depicts social media marketing for soccer.

FIG. 59 depicts social media marketing for upper body.

FIG. 60 depicts social media marketing for weight training.

FIG. 61 depicts social media marketing for kid fit.

FIG. 62 depicts social media marketing for mma.

FIG. 63 depicts social media marketing for motocross.

FIG. 64 depicts social media marketing running.

FIG. 65 depicts social media marketing senior fit.

FIG. 66 depicts social media marketing skateboarding.

FIG. 67 depicts social media marketing surfing.

FIG. 68 depicts social media marketing for wakeboarding.

FIG. 69 depicts social media marketing whole body.

FIG. 70 depicts information for trainers considering registration.

FIG. 71 depicts information for trainers considering registration.

FIG. 72 depicts information for trainers considering registration.

FIG. 73 depicts information for trainers considering registration.

FIG. 74 depicts information for trainers considering registration.

FIG. 75 depicts the trainer registration process.

FIG. 76 depicts the trainer registration process.

FIG. 77 depicts the trainer registration process.

FIG. 78 depicts the trainer registration process.

FIG. 79 depicts a guided tour for the Dashboard.

FIG. 80 depicts a guided tour for the Dashboard.

FIG. 81 depicts a guided tour for the Dashboard.

FIG. 82 depicts a guided tour for the Dashboard.

FIG. 83 depicts a guided tour for the Dashboard.

FIG. 84 depicts a guided tour for the Dashboard.

FIG. 85 depicts the Dashboard.

FIG. 86 depicts the Add a Contact portion of the Dashboard.

FIG. 87 depicts the listing of Contacts.

FIG. 88 depicts the entry for an individual contact.

FIG. 89 depicts the Notes for an individual contact.

FIG. 90 depicts the Messages for an individual contact.

FIG. 91 depicts the Tasks for an individual contact.

FIG. 92 depicts the Overview for an individual contact.

FIG. 93 depicts a Create Lead entry.

FIG. 94 depicts a Lead Stage for Create Lead entry.

FIG. 95 depicts a created lead with a lead stage.

FIG. 96 depicts a Create Client entry.

FIG. 97 depicts an individual client entry.

FIG. 98 depicts Notes for an individual client entry.

FIG. 99 depicts Messages for an individual client entry.

FIG. 100 depicts Tasks for an individual client entry.

FIG. 101 depicts Overview for an individual client entry.

FIG. 102 depicts Progress for an individual client entry.

FIG. 103 depicts Payments for an individual client entry.

FIG. 104 depicts a Calendar for an individual client entry.

FIG. 105 depicts the Clients Group.

FIG. 106 depicts the creation of a New Clients Group.

FIG. 107 depicts the Clients Group with an entry.

FIG. 108 depicts the Trainer Requests.

FIG. 109 depicts a guided tour of Tasks.

FIG. 110 depicts a guided tour of Tasks.

FIG. 111 depicts a guided tour of Tasks.

FIG. 112 depicts the Tasks section. In an embodiment, a trainer can enter tasks.

FIG. 113 depicts the Completed Tasks section.

FIG. 114 depicts the Workouts section.

FIG. 115 depicts the Guided Tour for the Calendar section.

FIG. 116 depicts adding a Task to the Calendar.

FIG. 117 depicts adding a New Calendar entry to the Calendar.

FIG. 118 depicts the Guided Tour for the Messages section.

FIG. 119 depicts the Messages section.

FIG. 120 depicts the Files section.

FIG. 121 depicts a mechanism for uploading a file.

FIG. 122 depicts a mechanism for creating a folder.

FIG. 123 depicts the Reports section.

FIG. 124 depicts the Settings section.

FIG. 125 depicts a mechanism to drag and drop a picture.

FIG. 126 depicts a section for Frequently Asked Questions.

FIG. 127 depicts a method to contact customer service.

FIG. 128 depicts a drop-down menu of section of the social section.

FIG. 129 depicts the Social Website.

FIG. 130 depicts the listing of groups.

FIG. 131 depicts the crossfit group page.

FIG. 132 depicts the soccer group page.

FIG. 133 depicts the Find a Pro section.

FIG. 134 depicts the messages page.

FIG. 135 depicts a blog section.

FIG. 136 depicts various professional workouts that can be selected. In an embodiment, the workout is a video. In an embodiment, the workouts can be searched by categories including but not limited to workout type, trainer, and/or level of fitness and/or skill.

### DETAILED DESCRIPTION

The particulars shown herein are by way of example and for purposes of illustrative discussion of the preferred embodiments of the present disclosure only and are presented in the cause of providing what is believed to be the most useful and readily understood description of the principles and conceptual aspects of various embodiments of the disclosure. In this regard, no attempt is made to show structural details of the disclosure in more detail than is necessary for the fundamental understanding of the disclosure, the description taken with the drawings making apparent to those skilled in the art how the several forms of the disclosure may be embodied in practice.

The following definitions and explanations are meant and intended to be controlling in any future construction unless clearly and unambiguously modified in the following examples or when application of the meaning renders any construction meaningless or essentially meaningless. In cases where the construction of the term would render it meaningless or essentially meaningless, the definition should be taken from Webster's Dictionary 3^{rd} Edition.

As used herein, the term “user” means and refers to an individual or business that avails of the features of the system and method.

### Summary

### Introduction

The present disclosure includes but is not limited to a platform, system, and method for managing interactions between individuals that wish to provide, wish to receive, or are interested in health and fitness services. In an embodiment, it is a virtual gym encompassed by an online social platform that enables individuals, fitness professionals and Health Clubs to interact and exchange fitness information through a unique and unprecedented user experience. Users obtain direct access to a global network of fitness information, Health Clubs across the Country and certified professionals of every discipline, while fitness professionals and Health Clubs gain the means to develop their personal/professional brand, multiply their clientele and generate income.

### Product and User Experience

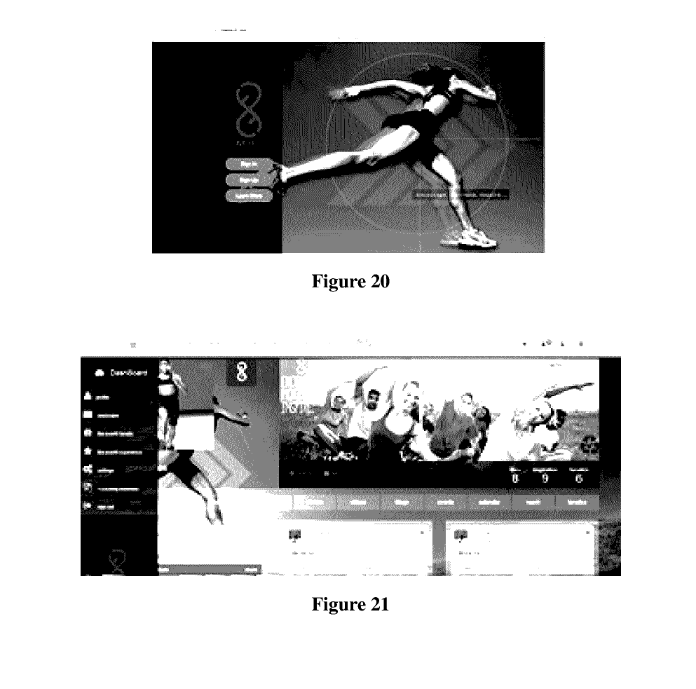

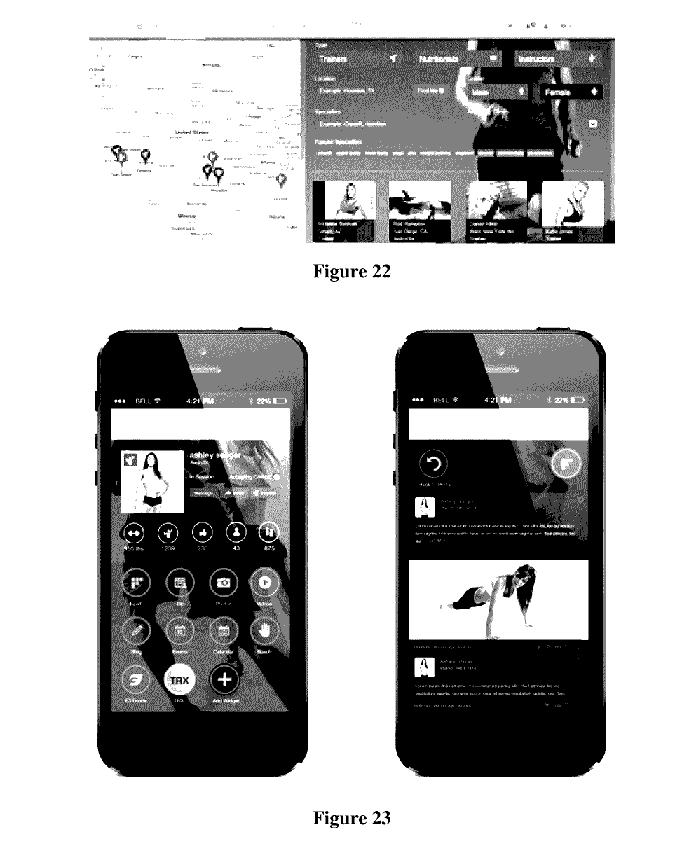

The system introduces a vibrant community platform for users to gain access to professional talent, receive meaningful guidance and feedback, and experience a fitness journey that goes beyond the typical 1-hour personal session. The system includes but is not limited to a variety of interactive features, online courses, live streaming videos, learning sessions, fitness articles, rankings and reviews, fitness trends, nutritional guidance and healthy meal delivery, inspire trainers and users with a sense of camaraderie, progress and achievement, through a constant interaction with no geographical boundaries. FIG. 20 depicts a page with the options to “Sign In”, “Sign Up”, or “Learn More”. FIG. 21 depicts a page including a dashboard. FIG. 22 depicts the map.

### Market Opportunity

The professional and social platform enhances and expands the way the fitness industry works through a unique combination of functionality that simultaneously serves the unmet needs of (1) fitness professionals, (2) members, and (3) fitness/health clubs and gyms.

### (1) Fitness Professionals:

Challenge: Professional development is restricted by the inherent limitations of time, hourly wage, and location. More than 70 percent of fitness professionals are getting paid on an hourly basis, with a median annual income of $42,000, while they struggle to develop their personal brand and monetize their strongest asset, their relationship with the customer.

Solution: The online platform empowers fitness professionals to create and broadcast fitness related content, thus enabling each individual to develop and market their own brand to clients searching for health and fitness guidance. Through the affiliate program, fitness professionals earn passive income through commissions paid monthly on purchases realized by their affiliates.

### (2) Members/Fitness Club Users:

Challenge: Lack of variety, location, and price leads to abandonment. In 2012, the high cost of membership is still the leading reason why members are quitting health clubs. Almost 50% of former members think it is too expensive to keep training in health clubs and quit. This, along with a lack of variety of available fitness classes and distance from home lead to 4 out of 5 gym memberships going unused.

Solution: The database offers all disciplines of fitness through pre-recorded and live streaming content enabling fitness members to search for, read up on, and interact with Professionals from the comfort of their home, without experimenting with multiple Health Clubs and accumulating expenses. An overwhelming variety of live fitness classes, through participating Fitness clubs from all over the US, can be purchased at affordable prices and at varying membership levels, similar to a typical gym membership. Individuals are no longer limited by lack of variety, location or cost.

### (3) Fitness/Health Clubs and Gyms:

### Challenge: Location and Price of Membership

According to the International Health, Racquet & Sportsclub Association (“IHRSA”), fitness clubs are limited to individuals residing within a 10-12 minute commute from their location. In addition, 58% of individuals who choose to not join a gym and 44% of individuals who quit their club do so for economic reasons, because it is too expensive.

Solution: The system amplifies the revenue stream of the gyms, rather than competing with them. The gyms receive a percentage on the revenues generated by the users viewing the gym's classes through the system platform. This increases each gym's sales footprint by an exponential factor and removes the location barrier while providing a flexible ‘per class’ pricing structure to users. Any fitness class can easily be shared on an individual's timeline or in one of the Fitness Groups posts. A single gym class could host 20 clients physically inside the gym while streaming the class live to over 1,000 other Members participating from their residence.

### Fitness and Social Media—Market Information

The Gym, Health and Fitness Club industry is a $27 billion market in the U.S. experiencing a 2.3% annual growth since 2009. According to Partnership Capital Growth, than ten thousand of the 78 million aging Baby Boomers turn 50 years old every day, with a vested interest to spend more on leisure and fitness related activities. As an example, participation in yoga classes has grown at ˜24% CAGR over the last decade with total spending nearly doubling since 2004 to $5.7 billion annually.

The system and method introduce the social media experience into the fitness industry. According to BIA/Kelsey, social ads helped social media companies generate $2.4 billion in revenue in 2013, up 77% from 2012 and U.S. social mobile ad revenues grew to $1.6 billion in 2013, up 250% from 2012.

Market size: In the U.S., the combined markets of fitness related product and organic food and beverage is $88 billion. In addition, 51.4 million gym memberships, with an average cost of $55 per month, contribute $34 billion in gym memberships annually and add to a total addressable market of $122 Billion.

### Market Strategy

In an embodiment, the system includes a direct marketing approach to market to and retain fitness professionals and individual clients. In an embodiment, the system provides an unparalleled user experience that produces advocates rather than customers or visitors.

In an embodiment, the business development and customer acquisition strategy for all types of users (individuals, fitness professionals, and fitness clubs) includes initiating targeted marketing campaigns rewarding referrals and incentivizing fitness professionals with a 5% sales commission from their affiliates purchases and users with a pay-back program accumulating discounts and store credits towards future purchases.

### Revenue Model

The system generates revenue through multiple streams:

(1) Sale of fitness products through a storefront;

(2) Nutritional meal delivery programs;

(3) Individual user fees for online training sessions;

(4) Live streaming gym classes; and

(5) Fitness professional membership fees for online training.

In an embodiment, there are more than 5,000 fitness products in the store front, healthy premade meals, supplements, organic products, a variety of fitness equipment and live streaming fitness classes.

The average fitness client spends between $50-150 per month on fitness-related memberships and products. Given the statistics on revenue generated from fitness equipment and health club memberships provided by Partnership Capital Growth, these are conservative estimates when compared to revenue-related statistics (for health club memberships and fitness equipment providers). In an embodiment, a projection is 5,000 users with a conversion rate of 8% from simple users to active users, with the users spending on average $50 per month on fitness products. In an embodiment, another projection is to reach 226,500 members, which would generate $23 million in revenues annually with a projected average margin of 33%.

According to IHRSA there were over 30,500 health clubs in the U.S. in 2012. In an embodiment, the plan will engage 610 clubs to stream daily classes. With more than 3 classes per day, that totals more than over 1,800 fitness classes, streaming live, on a daily basis. In an embodiment, with a user base of 226,500 and a conversion rate of 8%, all purchasing 2 classes per week at $2 per class, the revenue stream would produce an additional $3.4 million in revenues annually.

### User Functionality

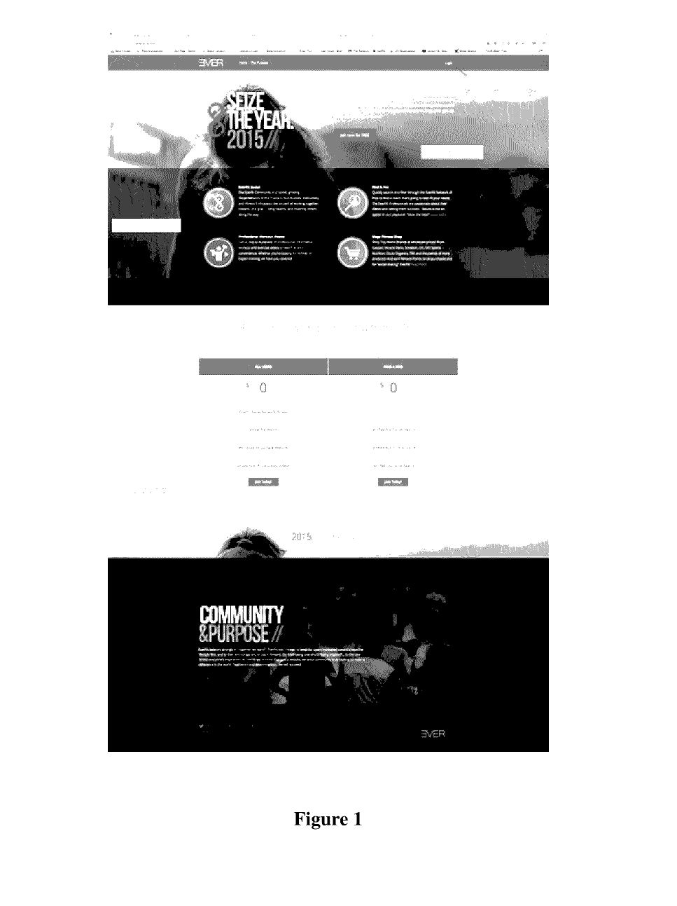

Landing Page: Multiple marketing funnels are set in place to bring the User to the Live Ever Fit Landing page. (FIG. 1). From the landing page the User is exposed to the benefits of EverFit via a short paragraph for each major functionality with the option to “read more”. This distinction lets the user gain access to more information at their own pace, and focus on what benefit is most important to them. Inside of each “read more” the user is visually stimulated with actual screen shots of the chosen benefit, with a “Join Now” button on the bottom of each page. Further down the page show the Pricing Grid for Users and Professionals both “FREE” to all. This grid is accompanied by a “Join Now” option for USERS and PRO SEARCH. Existing users can also Login at the top of each page.

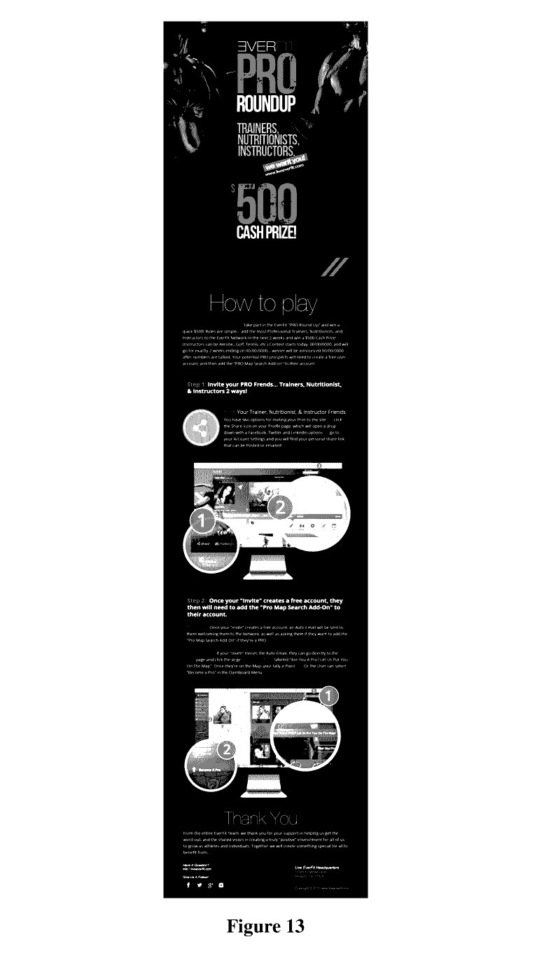

Registration: The USERS has a simple and short registration process as not to deter them from completing the task. Upon entering Name, email, password and “accepting the terms and conditions”, the user selects SUBMIT and is entered into the site via the Home Page. An email can be sent to incentivize the general users currently on the site to add “Professionals.” FIG. 13.

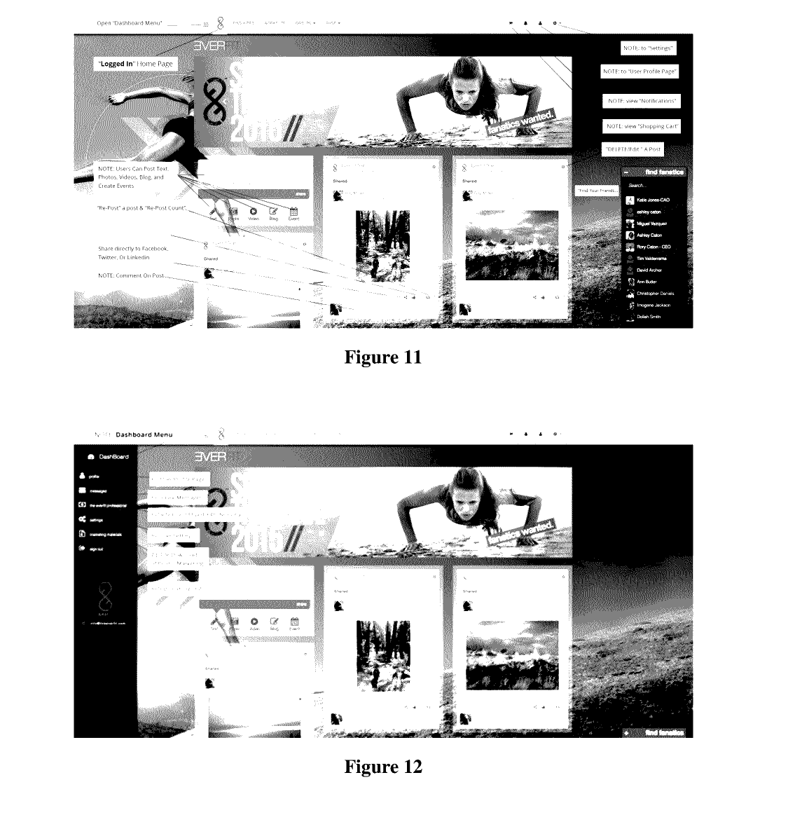

Home Page: The user will now visualize the Navigation Bar including easy access to: 1. Dashboard; 2. Find a Pro; 3. Workouts; 4. Groups; 5. Shop; 6. Cart; 7. Notifications; 8. Profile; and 9. Settings. Beneath the navigation bar the user will be exposed the site highlights and promotional material. This is conveyed with 5 auto sliding banners. This further instills our marketing efforts and value propositions of the website to our customers/users. FIG. 11 and FIG. 12.

The user has the ability to scroll 3 columns of News Feed. This news feed is comprised of site selected “Featured Trainers”, company posts, as well as any other Users they are following.

Status Box: The user has the ability to: Type plain text; Upload a photo; Upload a video; Compose a blog; and Compose an event. All posts within the status bar have the ability for the user to “TAG” a group, topic, and person. All posts within the status bar have the ability to “MENTION” another users via the “@” symbol followed by an autofill USER DATABASE as they type the individual they want to tag.

Within the 3 columns of news feed, the user has the ability to: Like and Share to Facebook, Twitter, and LinkedIn; and Share to the users own news feed. The ability to share a post externally increases the Users exposure to other potential users, and encourages them to also join the system website.

Gear Icon: The user has the ability to delete a post they have made.

The user has the ability to FLAG an inappropriate post for management to review.

Post Sharing Externally: The user and professional both have the ability to share externally to their own social media accounts. Within this “share” is an embedded link tied to the USERS/PROS ID number. This ID number is assigned at registration through Shopify. When an outside user clicks the external post, they are brought to the landing page to sign up. From that sign up, they become TIED to the initial users ID number as mentioned above. Any purchase that the TIED user makes from the Ever Fit Store will generate 5% commission of that purchase to the initial POSTER.

FIND FANATICS is located at the bottom right of the page is a banner signaling the user to open the “+Find Fanatics”. The entire database of Users/Professionals is loaded in the backend, displaying 12 random names with profile images. The user can SEARCH the database and select a name. Selecting the name will bring the user to the selected profile. The user can also select a preloaded name form the random 12 displaying.

Taking the Tour: The user is prompted to click the next buttons through a series of slides that explains the functionality mentioned above.

The user may also choose to close out the tour via X.

The NAVIGATION BAR includes a Dashboard in which the user can select from: Profile, Messages, The EverFit Fanatic, The EverFit Experience, Settings, Marketing Materials, Become a Pro, Sign out, or their profile. The user's name is presented on the top along with their profile picture. The profile picture can be changes by clicking on the camera icon and uploading a photo from their mobile device or computer. Listed under their profile picture is SPECIALITIES. The user can change their selected specialties from the SETTINGS.

On the “Advertisement” cover photo the User can view Likes; Inspiration (how many comments they have posted); Fanatics (# of followers); External Share link to Facebook, Twitter, LinkedIn; Settings icon (all settings icons have identical functionality), and Message icon (all message icons have identical functionality).

The user has a series of benefits from their profile page through feed FILTER buttons (Feed: entire newsfeed; Bio: the users bio (ability to change in the settings); Transformation (folder for tagged posts “transformation”); Text (text only filter); Photos (photos only filter); Videos (videos only filter); Blogs (blog only filter); Events (events only filter); Calendar (the users personal public calendar, the user can CREATE events with full calendar functionality scheduling including date and time and the created events are then posted to the user's newsfeed automatically); and Fanatics (the users list of who they are following, inside of the Fanatics Filter the user can scroll all of the other users they are following and the user can also select any profile from their fanatics list and view that profile by clicking on the profile picture). The same three newsfeed columns are also located on the profile page. The user profile has all of the same features and access via the newsfeed as mentioned above in Home Page. FIG. 19

When viewing ANOTHER USER/PROFESSIONALS PROFILE, in addition to all functionality listed above, the user may click: Share (external share to FB, Twitter, LinkedIn); Message (selected professionals profile user is viewing); Follow/Unfollow (selected professionals profile user is viewing); or Block (selected professionals profile user is viewing).

Messages: The user has the ability to compose a NEW message. The TO: is auto-populated with the User database as they type. The SUBJECT is plain text and the BODY is plain text. The user can access the Inbox; Sent; and Deleted items.

The Fanatic: The user is presented with verbiage on the benefits of the rewards program. This verbiage provides them with detail benefits, as well as visual guidance how to grow and share their network to maximize the benefits of the rewards program.

The Experience: The user can read “What to expect from Online Training or Nutritional Coaching?” This document reiterates the benefits of a coach/trainer and encourages the user for making the first step in increasing their personal health goal by joining the program. The user is also provided with a customer service email for comments/feedback.

### Settings:

User: By selecting edit the user can change their email address, password, bio, interests/specialties and copy/paste their individual share link tied to their Shopify ID as mentioned above. The Referral link can be copy/pasted to share via email, or text. The user also has the option to become a Fitness Pro by clicking the appropriate link.

Professional: In addition to user settings access: The professional may “check box” Accepting Clients? By checking the box the professional is turning Accepting Clients ON. When Accepting Clients is turned ON, a GREEN light will illuminate on the professionals profile. When Accepting Clients is turned OFF, a RED light will illuminate on the professionals profile. The professional may also enter their social media accounts for personal reference. The full dollar amount of referrals sales is reflected year to date. The professional will receive 5% of the current new monthly sales every month. The number of referrals tied to the professional is reflected. There is also a way to contact the administrator. The professional's certifications on file are listed. They may edit these at any time.

In an embodiment, there is also a cancel membership link. An email is generated to “info” with the information and reason for cancellation the user has provided. In an embodiment, there is a link to upgrading to become a fitness pro: The user is prompted to authenticate the upgrade via confirming their email address and password. Then selecting Upgrade Membership or Cancel Membership. In an embodiment, upon selecting Upgrade Membership the user can select Trainer (5% commission, Map visibility); Nutritionist (5% commission, Map visibility); Instructor (5% commission, Map visibility); and/or Promoter (5% commission, No Map visibility). The trainer then enters personal information such as phone number, experience, and certifications. Upon hitting submit, the user, is informed of the submission as well as the 24 hour ACTIVATION time until their profile populates the map and their profile is visible to other users. The Customer Service team reviews the experience and certifications for authenticity and validation. Upon approval the Pro is then ACTIVATED. An activation email is auto signaled to the Professional.

Marketing Materials: The user/professional may download a zip file to their computer containing the official marketing flyers for distribution to their other social media links to assist in promoting themselves on the system.

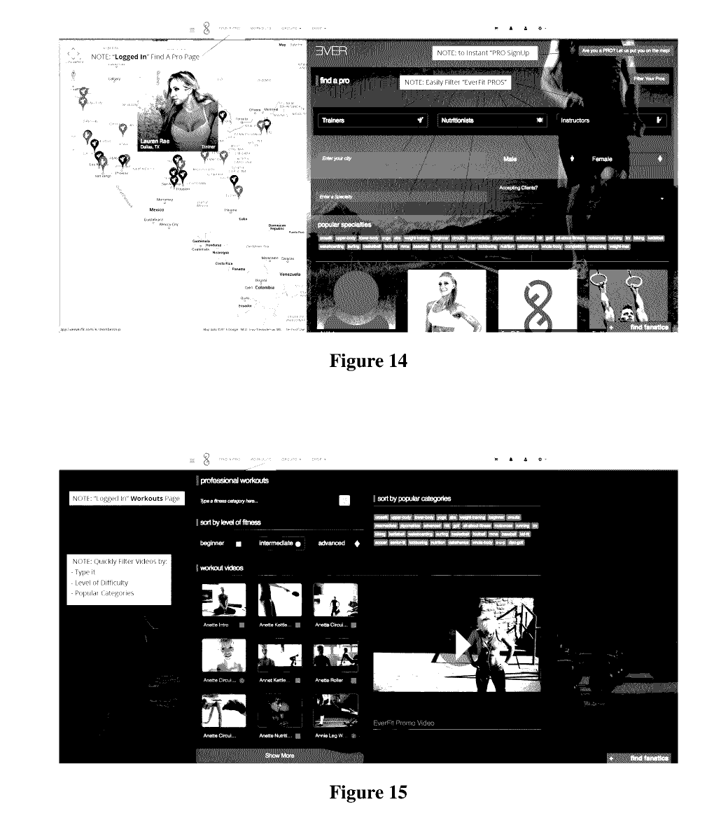

Find a Pro: The user will see Fitness Professionals profile pictures randomly populated. Next to the professionals is the Map with color coded markers of the geographic location of the trainers/nutritionists/instructors. In an embodiment, the following will be shown: Are you a PRO? Let us put you on the Map! Button for the user to upgrade to a pro directly from the Map. In an embodiment, a user can Filter your Pros: Filter by Trainers, Nutritionists, Instructors, male, female; an Option to enter your city to narrow search; an Option to enter specialties/interests to narrow your search; and an Option to select Accepting Clients: Yes, No, All. The select filter will apply and display results. Once a Pro is selected, the user can click on their profile to view the full profile. The user may communicate with the professional via comments, messages, and blog posts. FIG. 14.

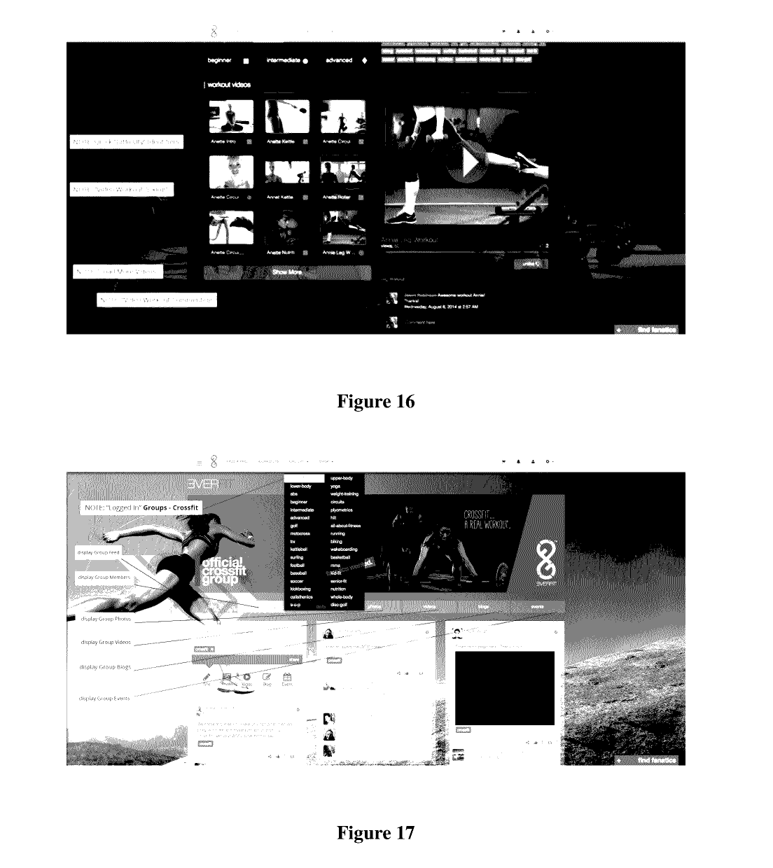

Workouts: The user has the option to watch a library of free fitness videos based on the filters they select. The users may type a fitness category of choice to filter. FIG. 15 and FIG. 16. The user may also select a pre-loaded category sorted by popularity. The user may select a video based on difficulty such as Beginner, Intermediate, or Advanced. The videos will populate according to the users selected filters. Upon selecting a video: the video expand for viewing. The user may also expand the video full screen. Underneath the selected video the user may “like” and comment on the video. The user may surf user profiles by selecting the profile by the users name attached to the comments. This option to click user names from comments throughout the site is available. By selecting the name the user can view the profile.

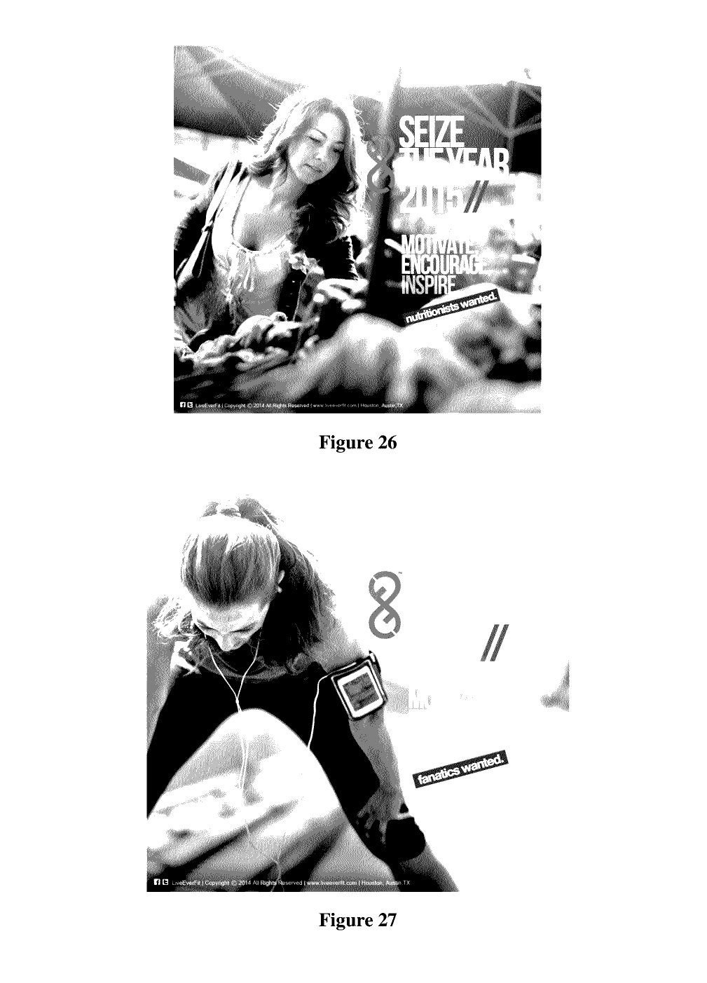

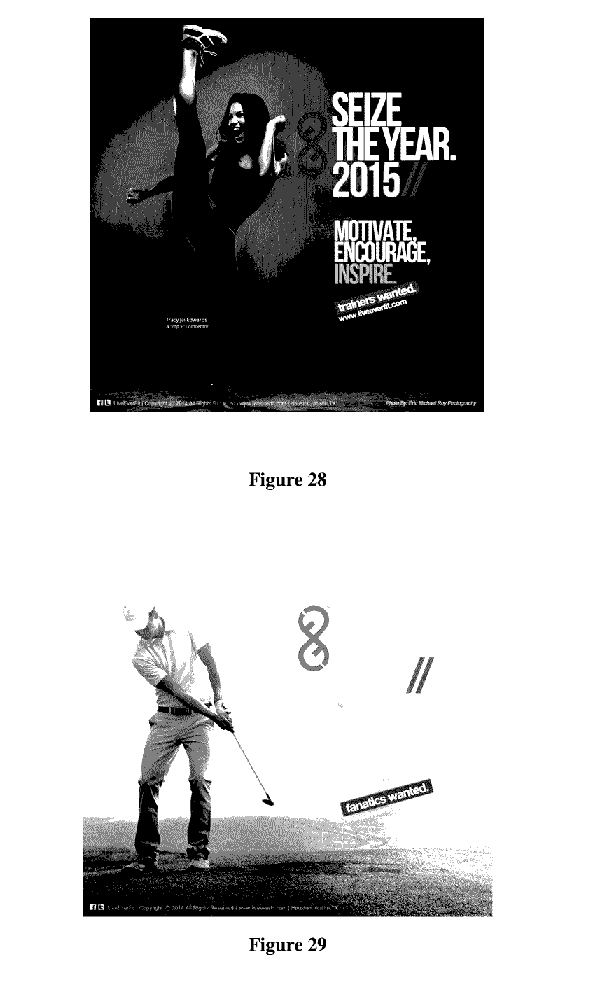

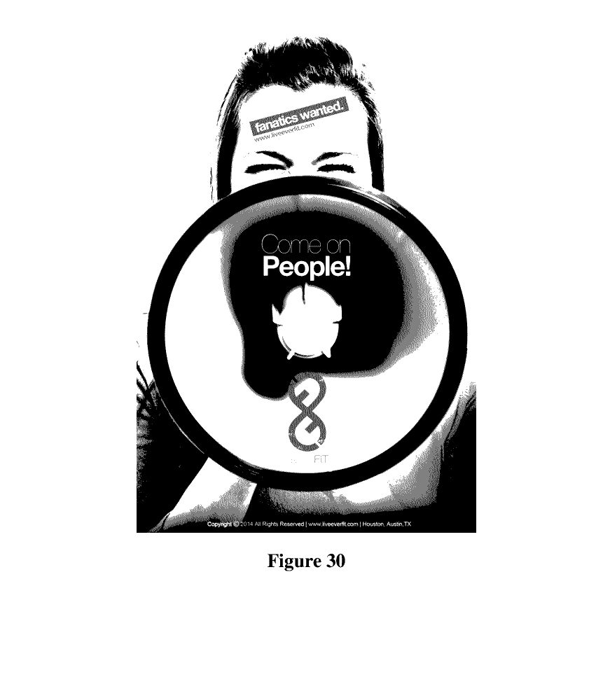

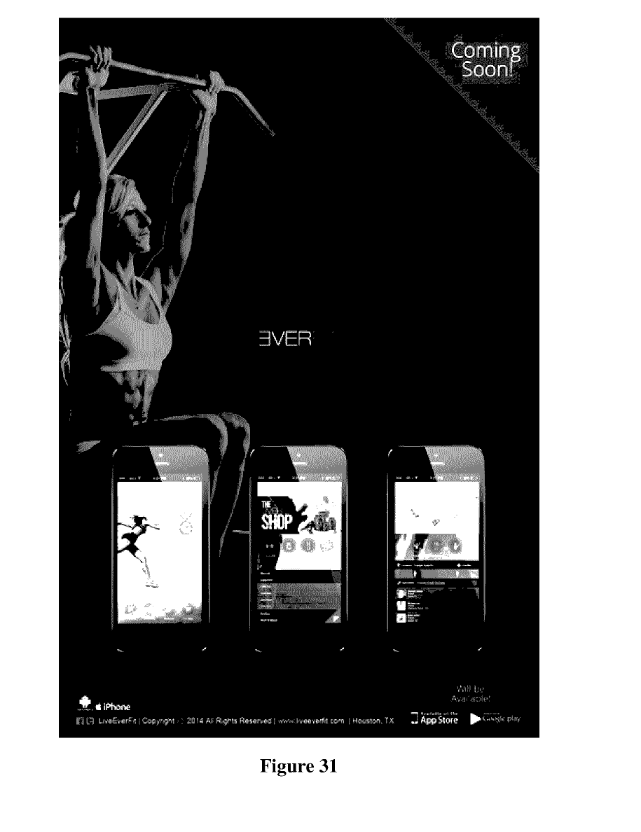

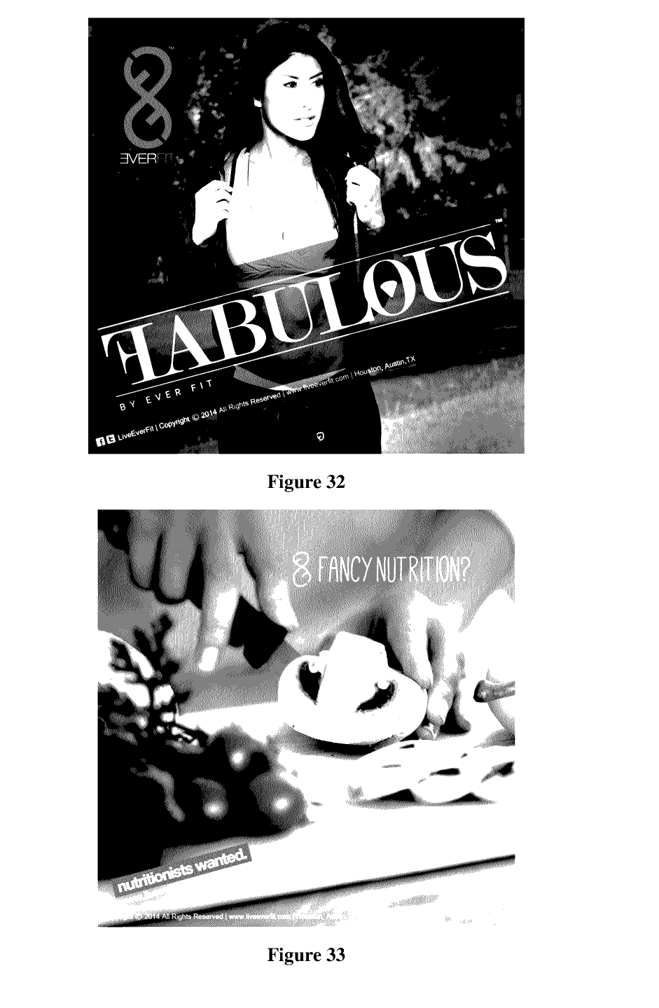

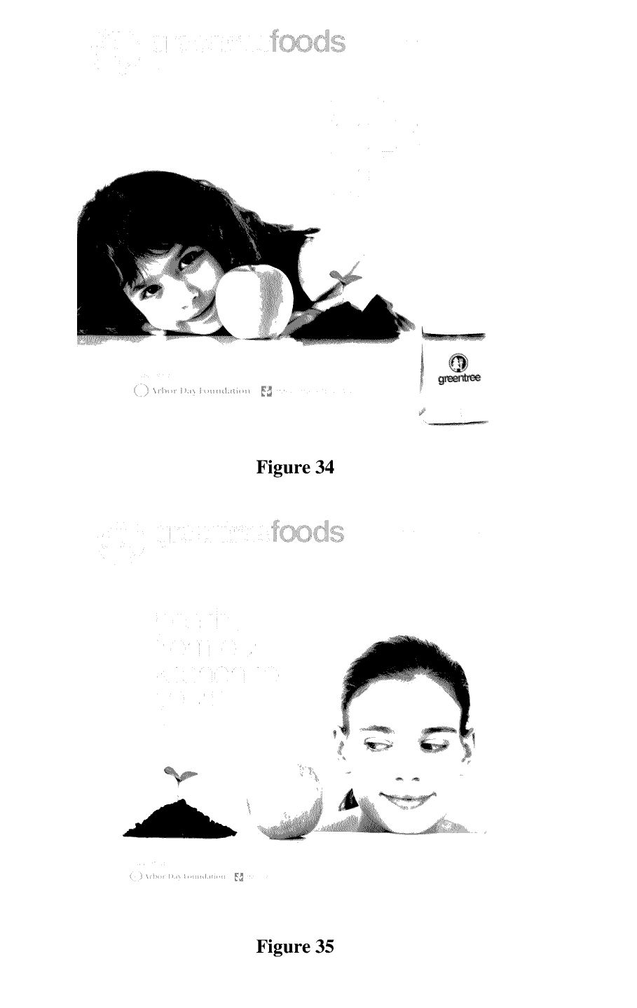

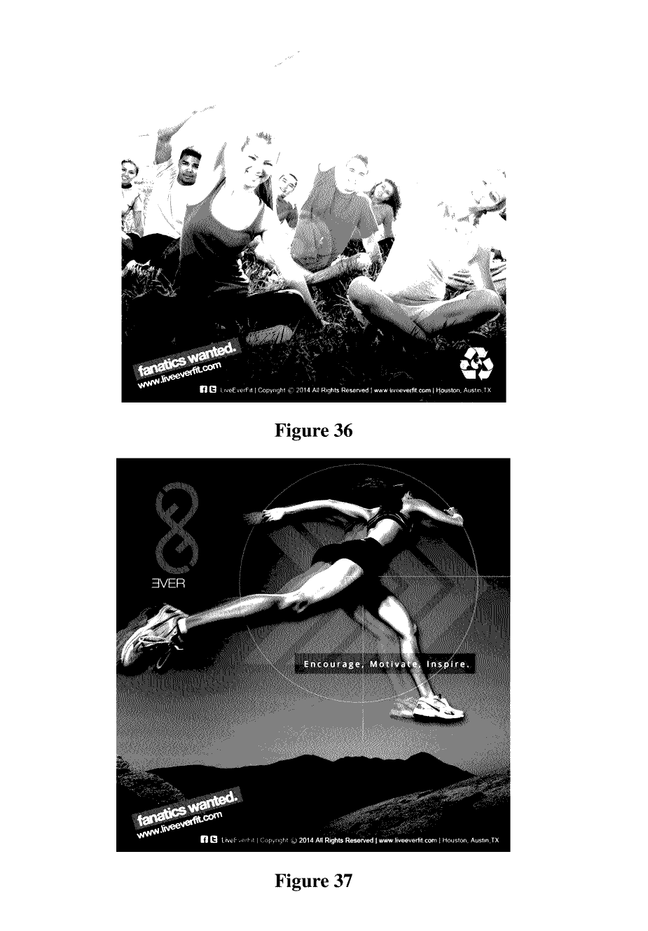

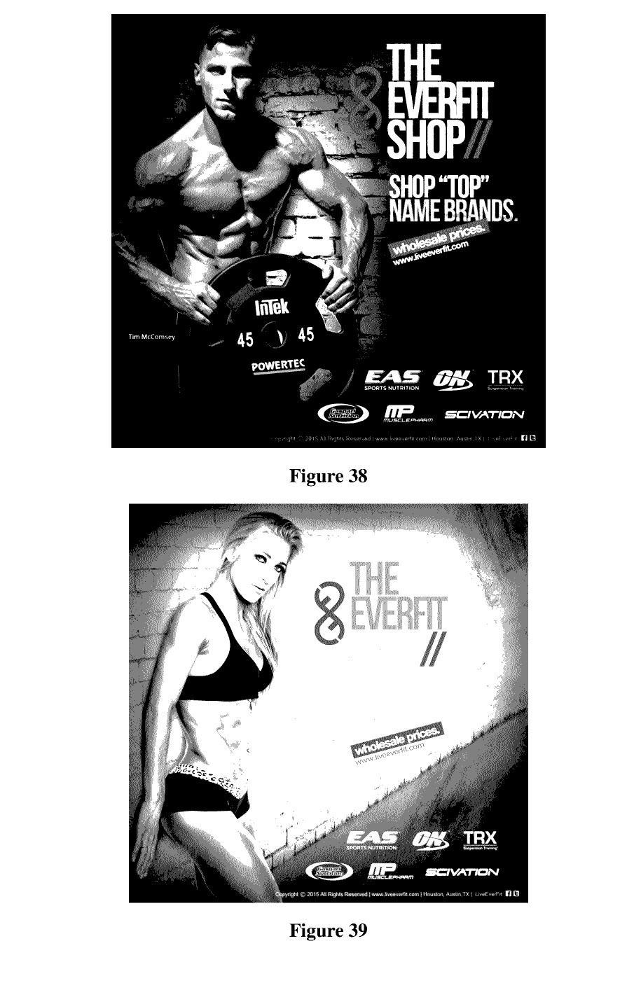

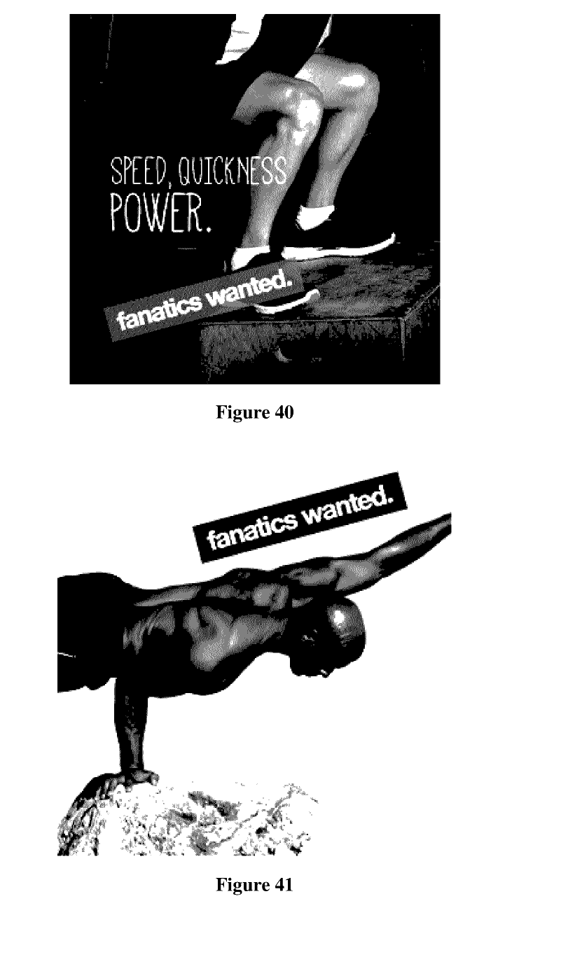

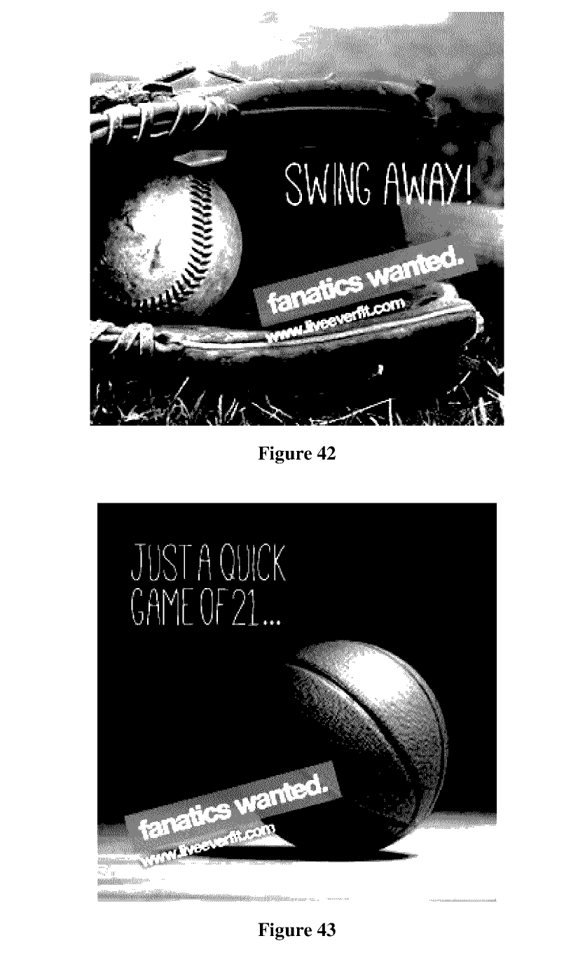

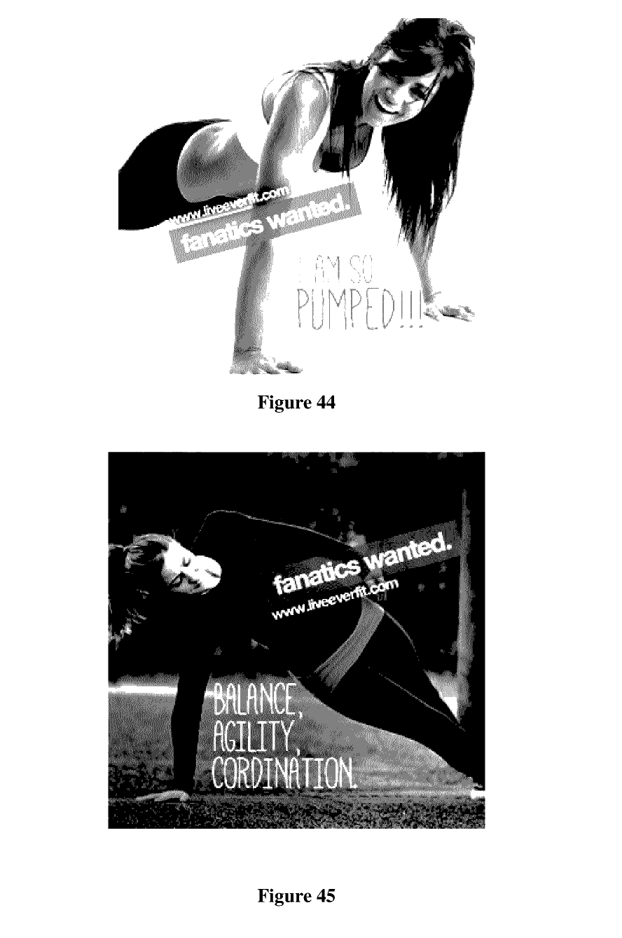

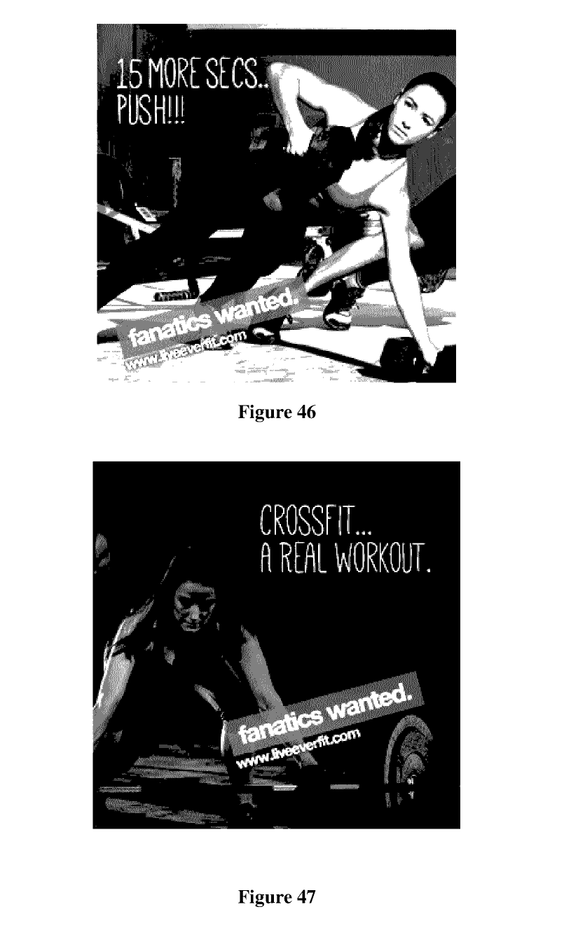

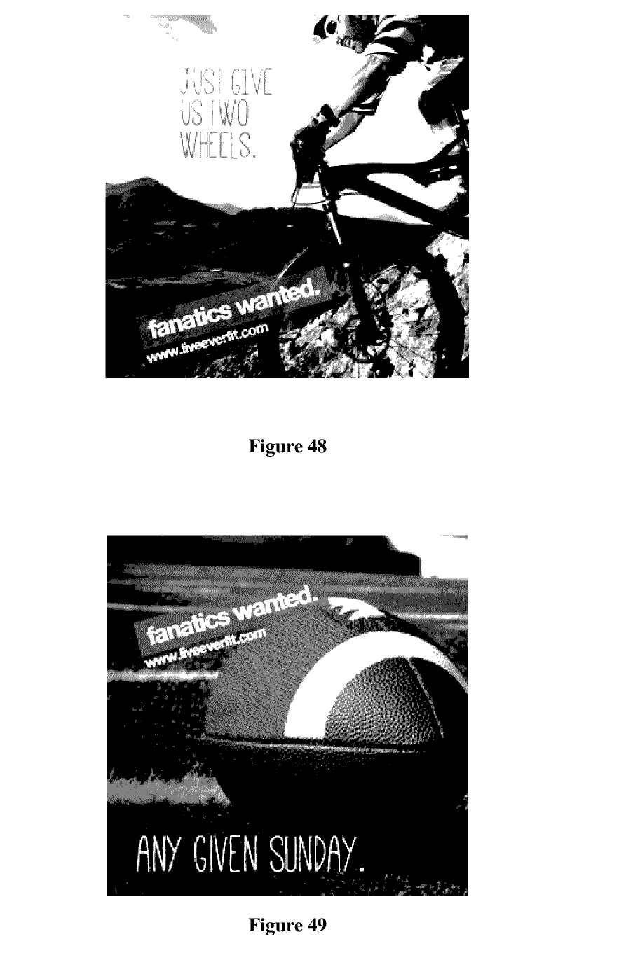

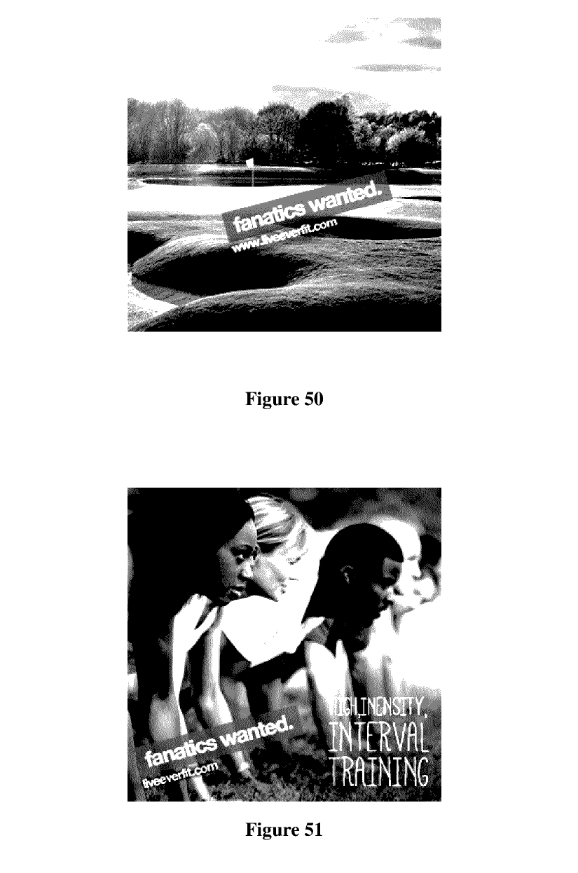

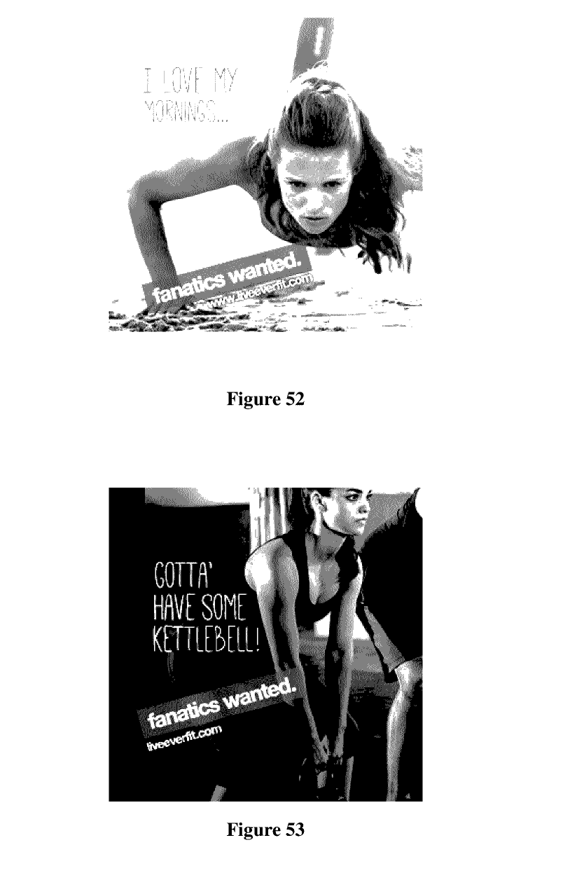

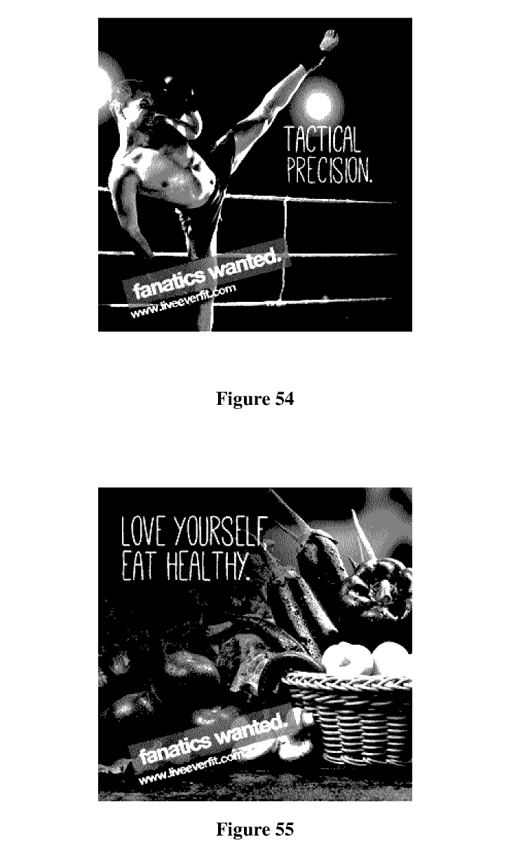

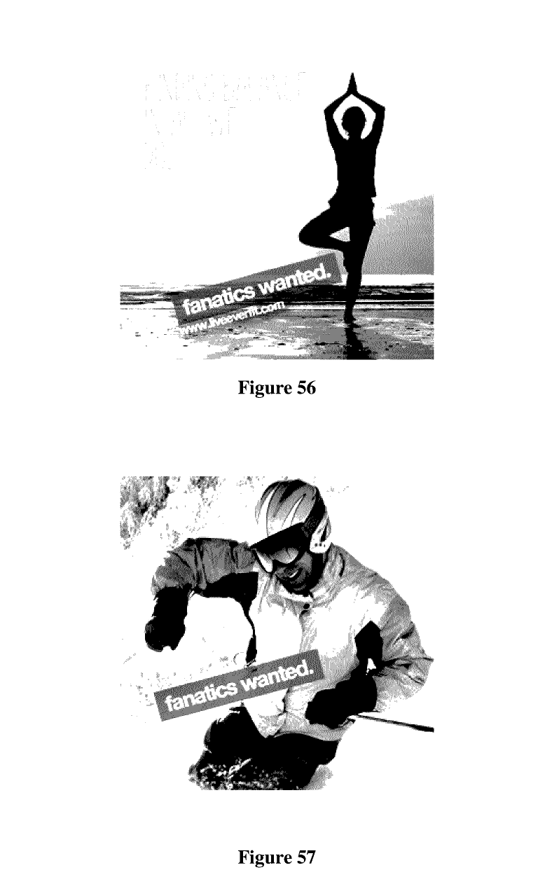

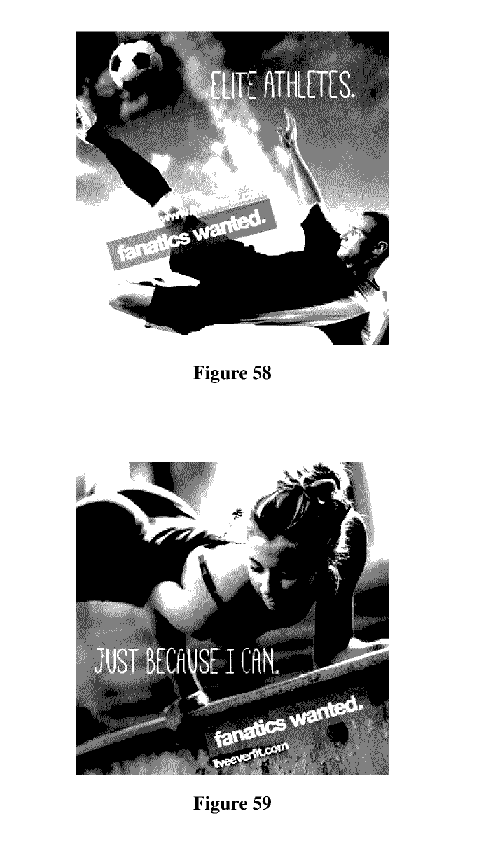

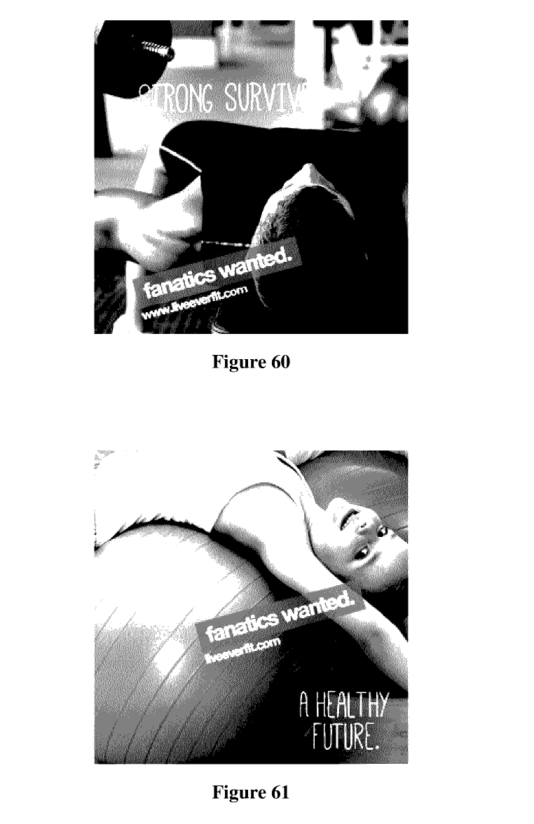

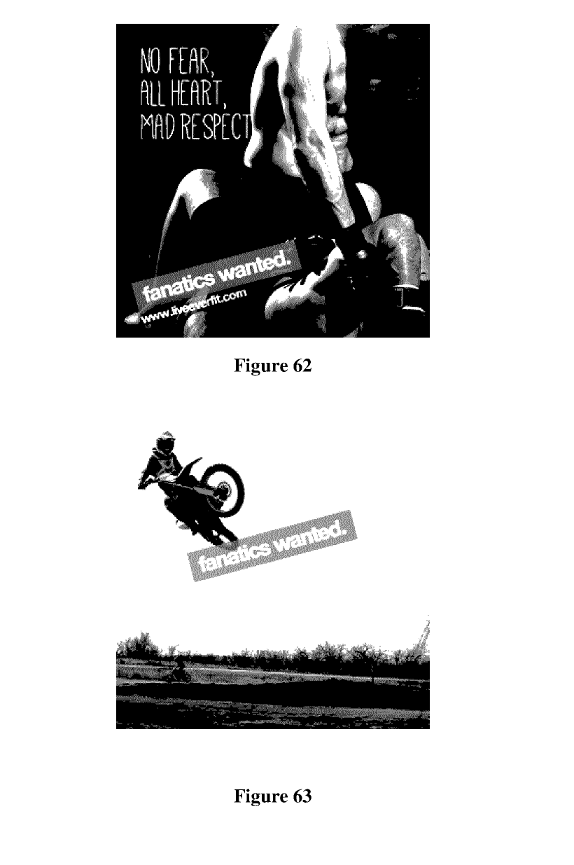

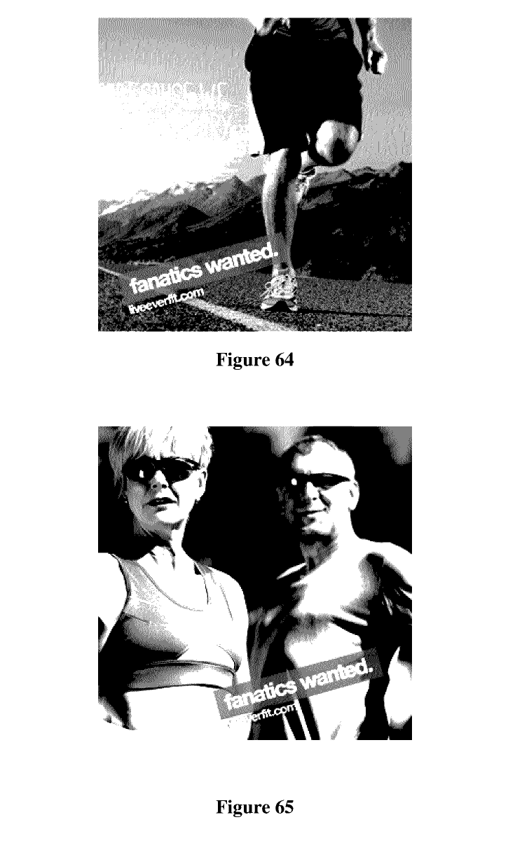

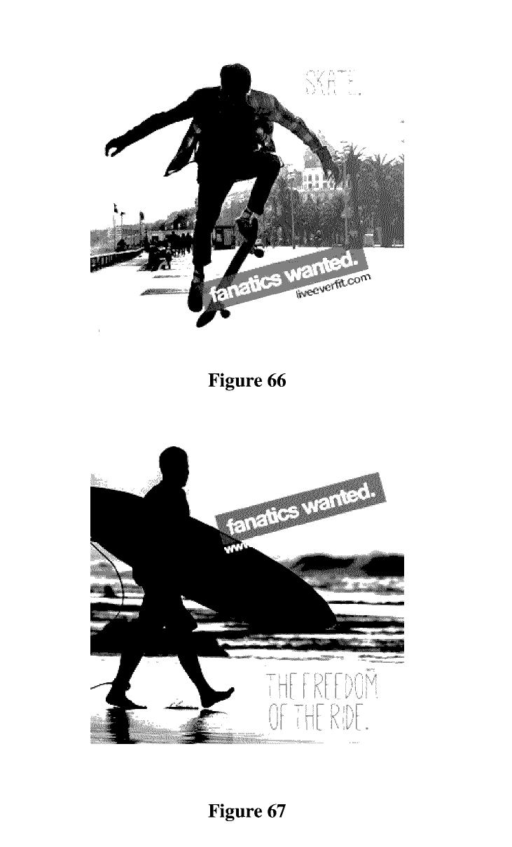

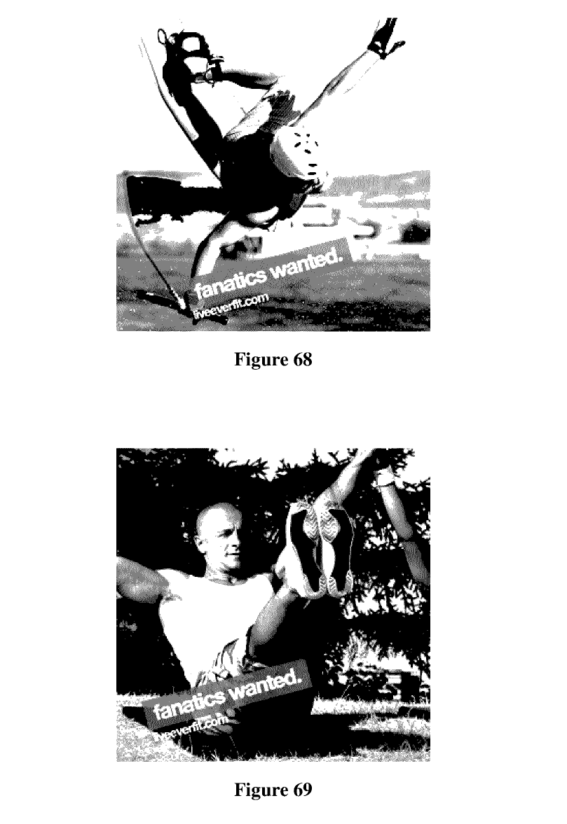

Groups: The user will visualize a drop down containing all of the Official Groups. In an embodiment, the groups cover most areas of fitness and hobby: Cross fit, Lower-body, Abs, Beginner, Intermediate, Advanced, Golf, Motocross, Trx, Kettlebell, Surfing, Football, Baseball, Soccer, Kickboxing, Calisthenics, S-u-p, Upper-body, Yoga, Weight-training, Circuits, Plyometric, Hiit, All-about-fitness, Running, Biking, Wakeboarding, Basketball, Mma, Kid-fit, Senior-fit, Nutrition, Whole-body, and Disc-golf. FIG. 17. FIG. 26-FIG. 69 show social media marketing for various groups. When a user selects a group they will view 3 columns of newsfeed specific to the selected group. Post filter to these selected groups based on the group name placed in a “TAG” of another post. The user may also post directly to the group via the STATUS BAR located in the left column. The STATUS BAR has the same features as the main status bar mentioned above. The user may filter the group feed as follows: Feed (all); Fanatics (other users in the group); Texts (plain text filter); Photos (photo filter); Videos (videos filter); Blogs (blogs filter); and Events (events filter). Upon selecting Load More anywhere on the site, the feed will populate the main feed.

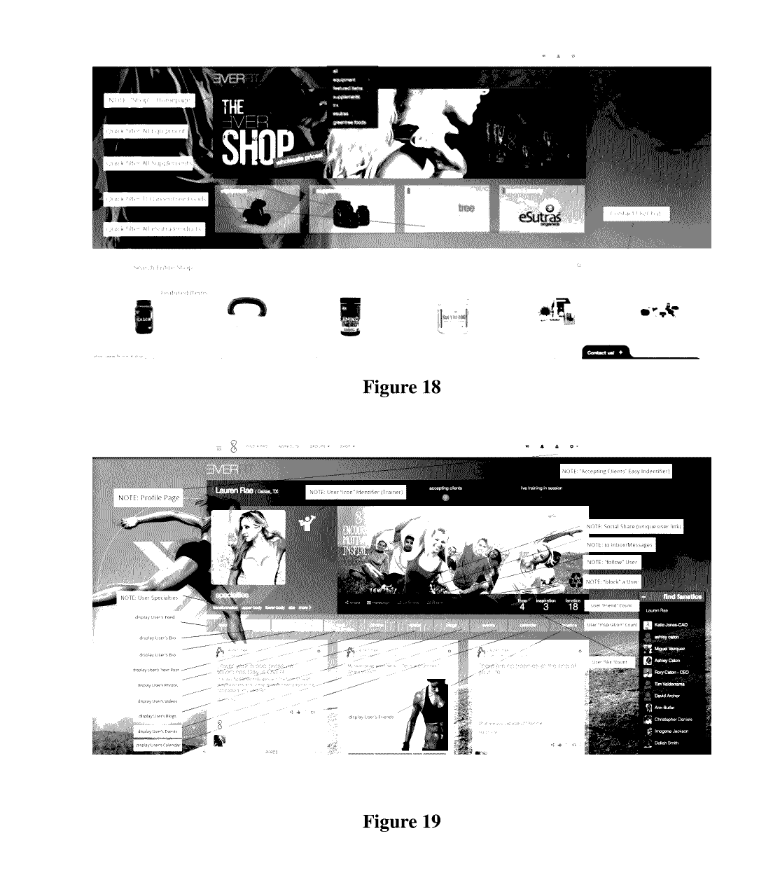

Shop: In an embodiment, the user may select from the drop down: All; Equipment; Featured items; Trx; Esutras; Streaming classes; or Greentree foods. FIG. 18. Upon selection of “all” the user is presented with the 6 Featured Products on the website. They may also choose the SEARCH ALL PRODUCTS site wide search. The user may select LIVE CHAT on the bottom of the screen. The user will view the same 5 marketing banners located on the homepage. Upon selecting a product, the user then may add the item to the cart and proceed to checkout or continue shopping.

Reward Program: The user will see the dumbbell icon located underneath each product. Next to the dumbbell icon will show and equivalent of pounds (lbs.) to the same dollar ($) amount of the product. Upon purchase of this product the user with gain the appropriate amount of points. Points: 1 point=1 pound=$0.01 USD (1%) in store credit. The user can continue to gain pounds from every purchase and either redeem them for store credit or save them for a later purchase.

The user may also share their “Share Link” to other social media sites. When an individual click that link, signs up for free (as mentioned in Professionals Commission Structure) the new user now becomes TIED to the initial user via their Shopify ID. The existing user will now gain $0.01 (1%) of anything the new user purchases from the store.

Returns: The user may check the status of a return, or return an item via this page. By providing a customer email and order number the user may look up their return.

### Trainer Manager

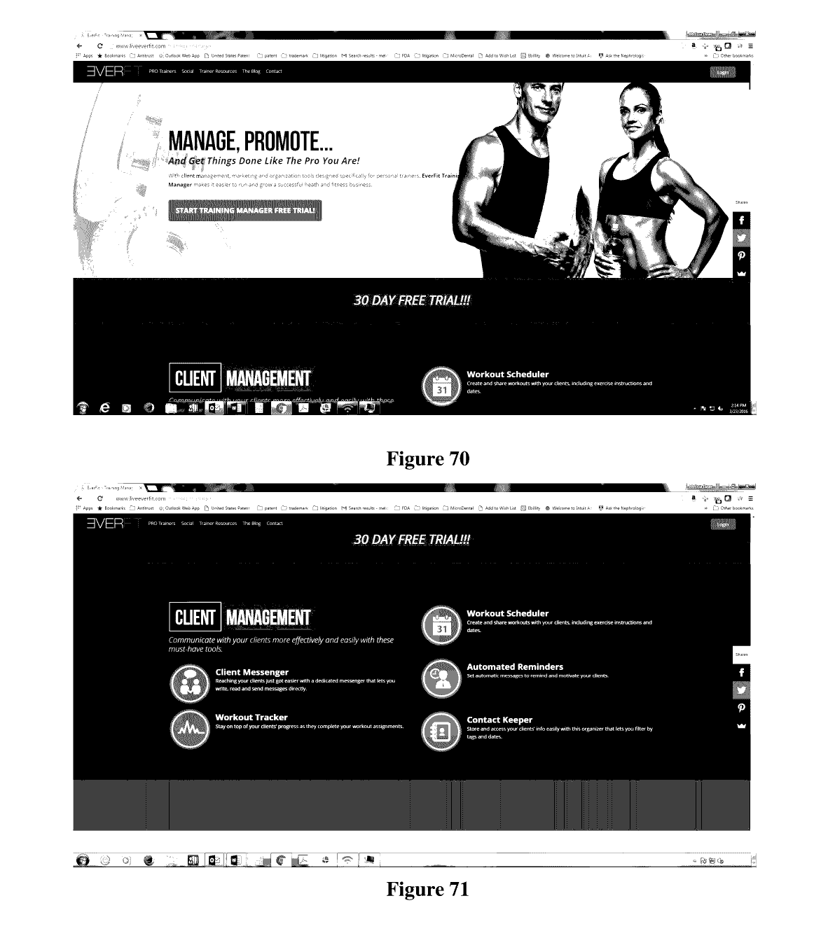

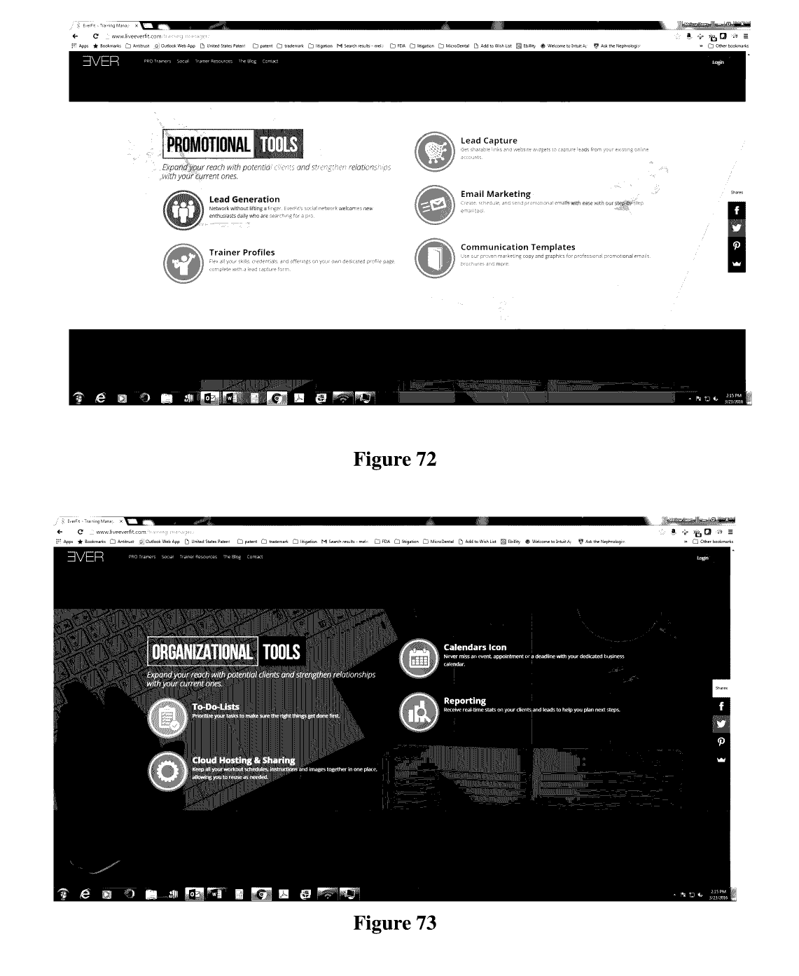

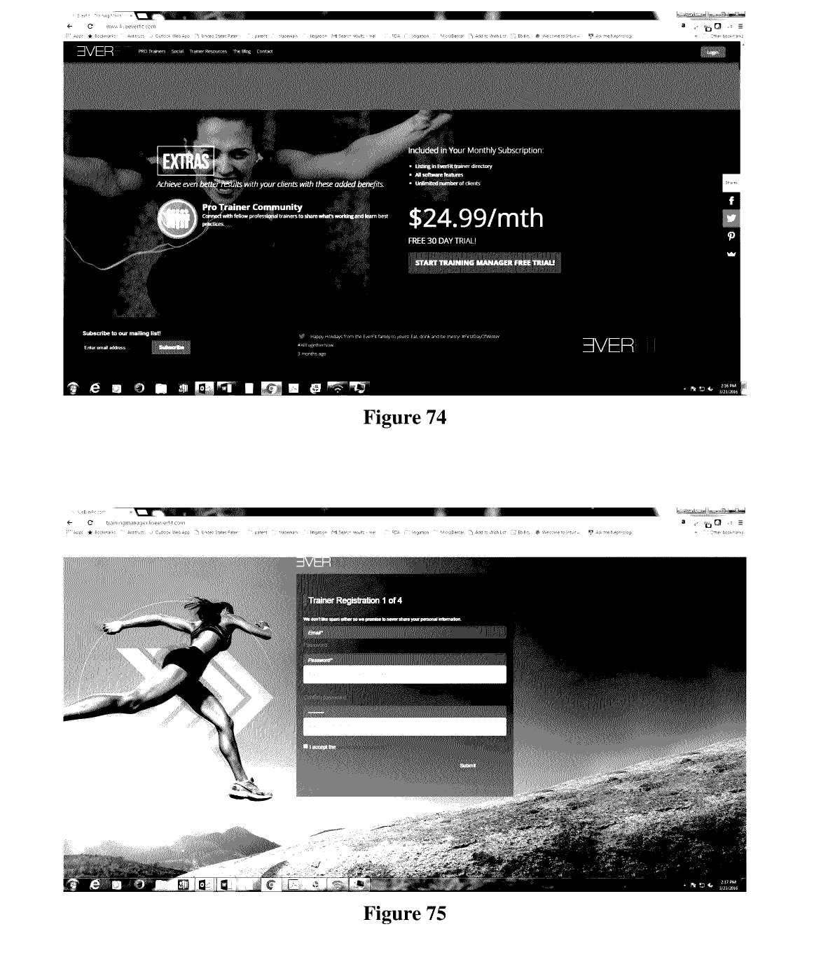

FIGS. 70-74 depict information for trainers considering registration.

In an embodiment, a trainer manager module is present. In an embodiment, there is a menu on the side of the window. In another embodiment, the menu can be on the left side, right side, top, or bottom of the window.

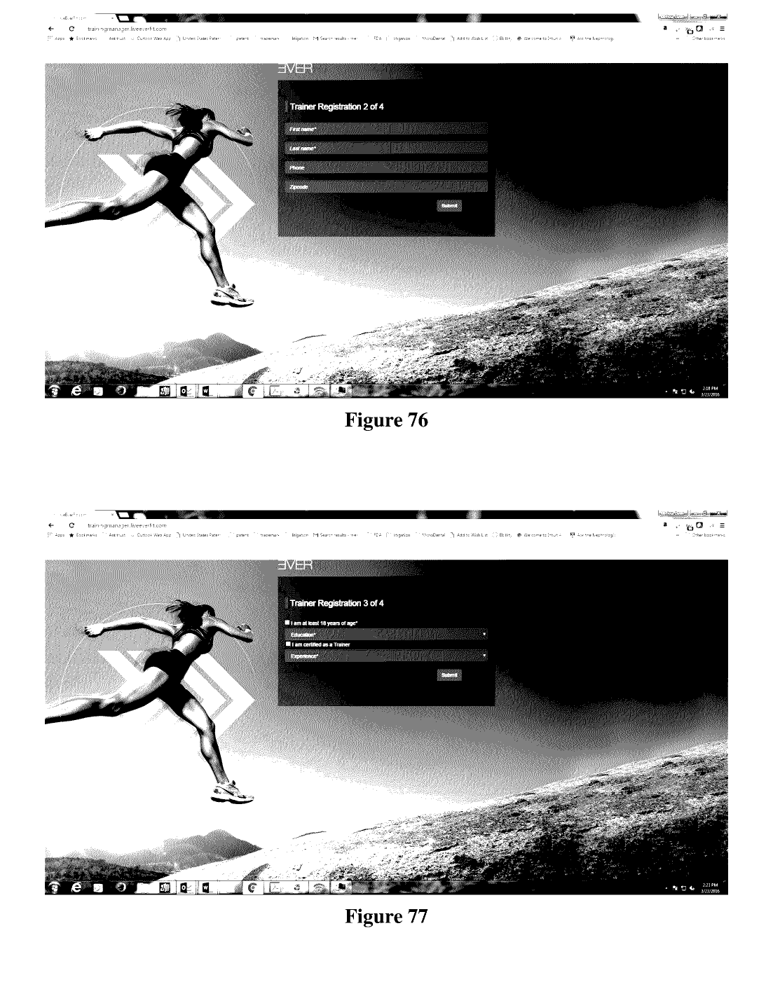

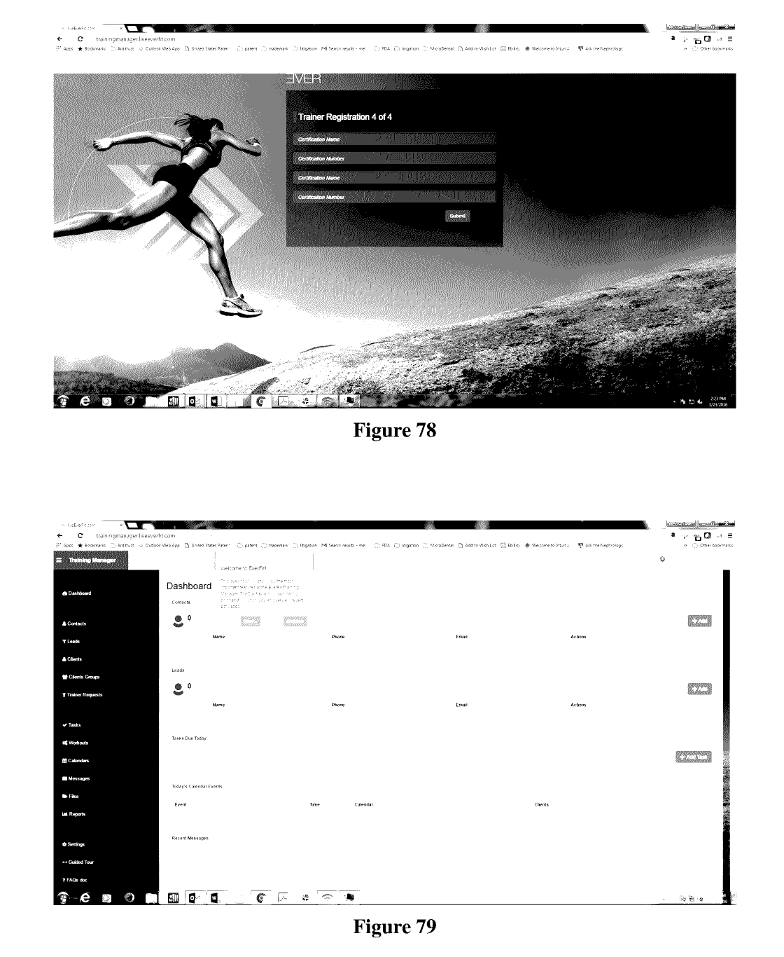

FIGS. 75-78 depict the trainer registration process.

### Dashboard

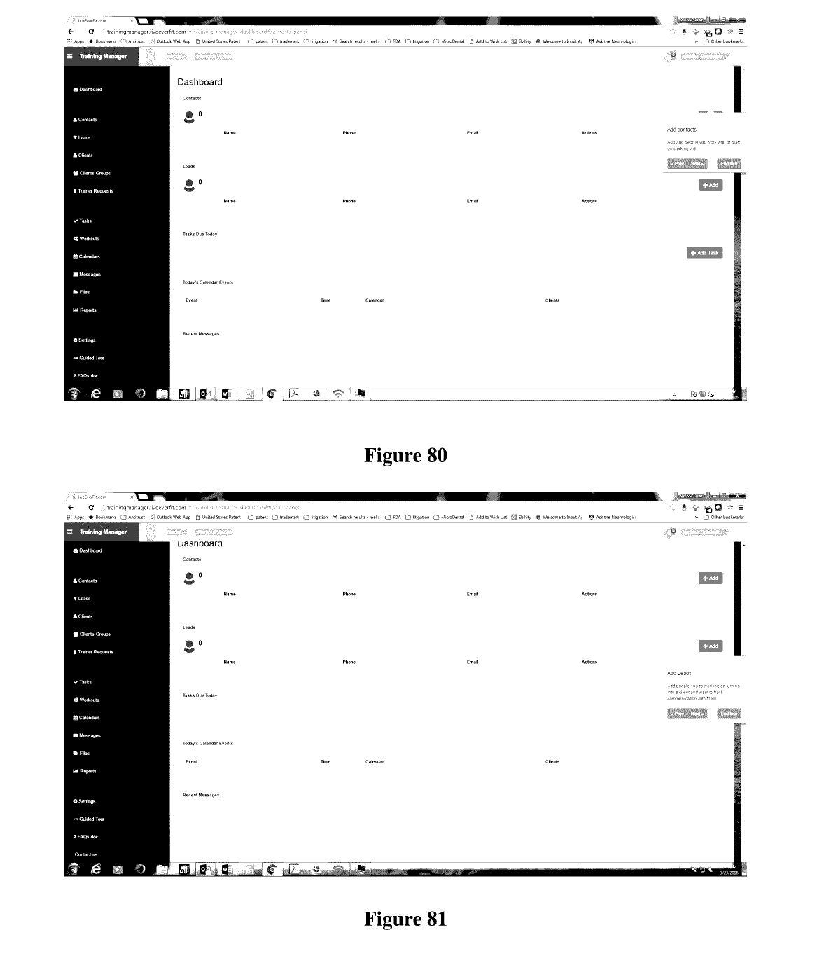

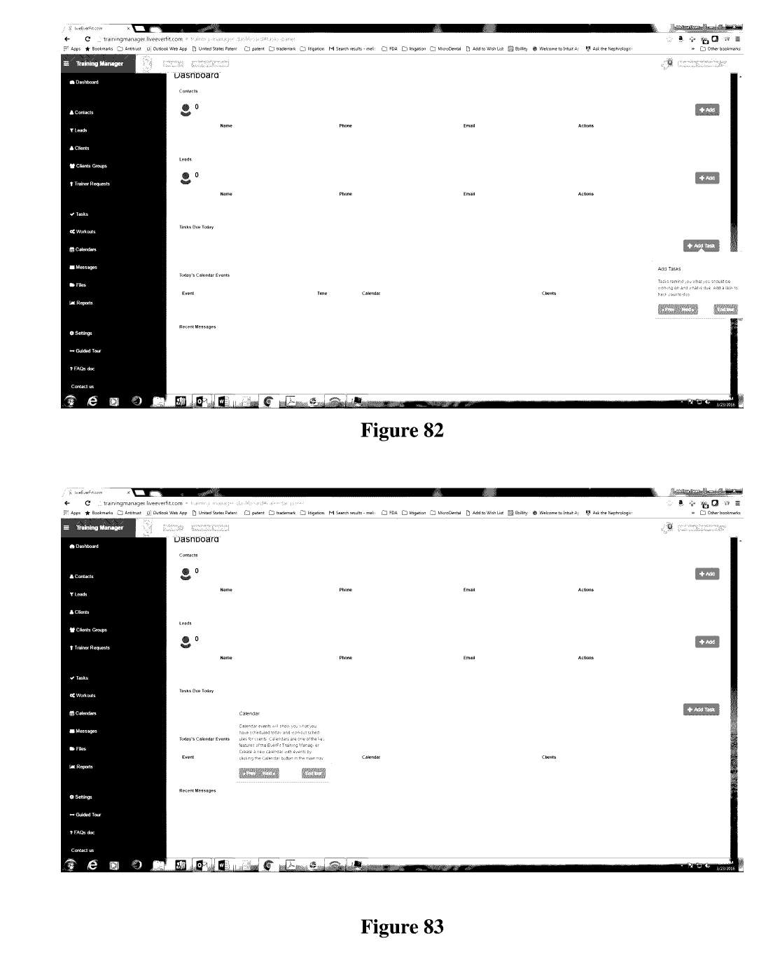

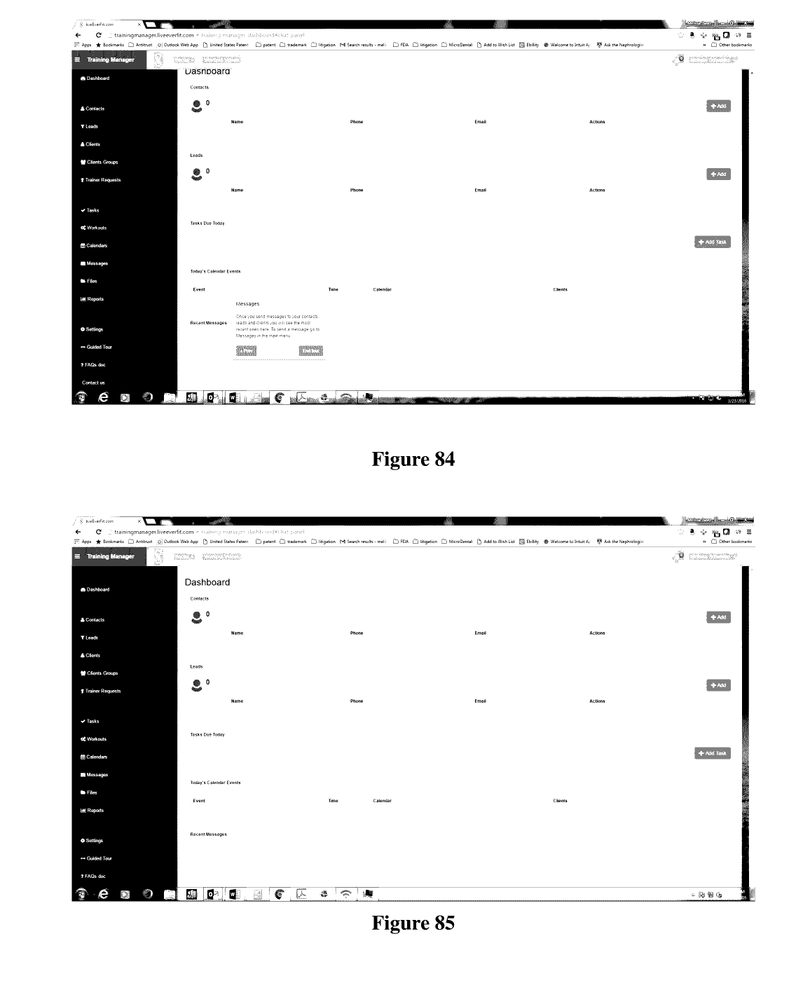

FIGS. 79-84 depict a guided tour for the Dashboard.

FIG. 85 depicts the Dashboard.

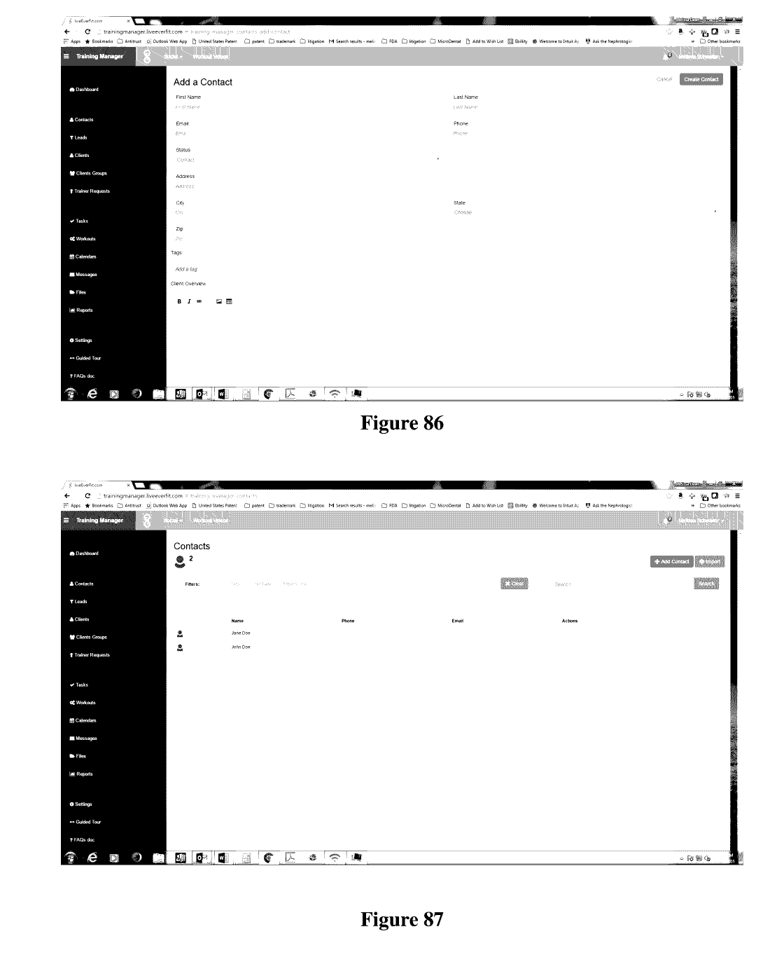

FIG. 86 depicts the Add a Contact portion of the Dashboard. In an embodiment, the trainer can upload contacts from elsewhere. In an embodiment, the trainer can classify the contact as a lead or a client.

FIG. 87 depicts the listing of Contacts.

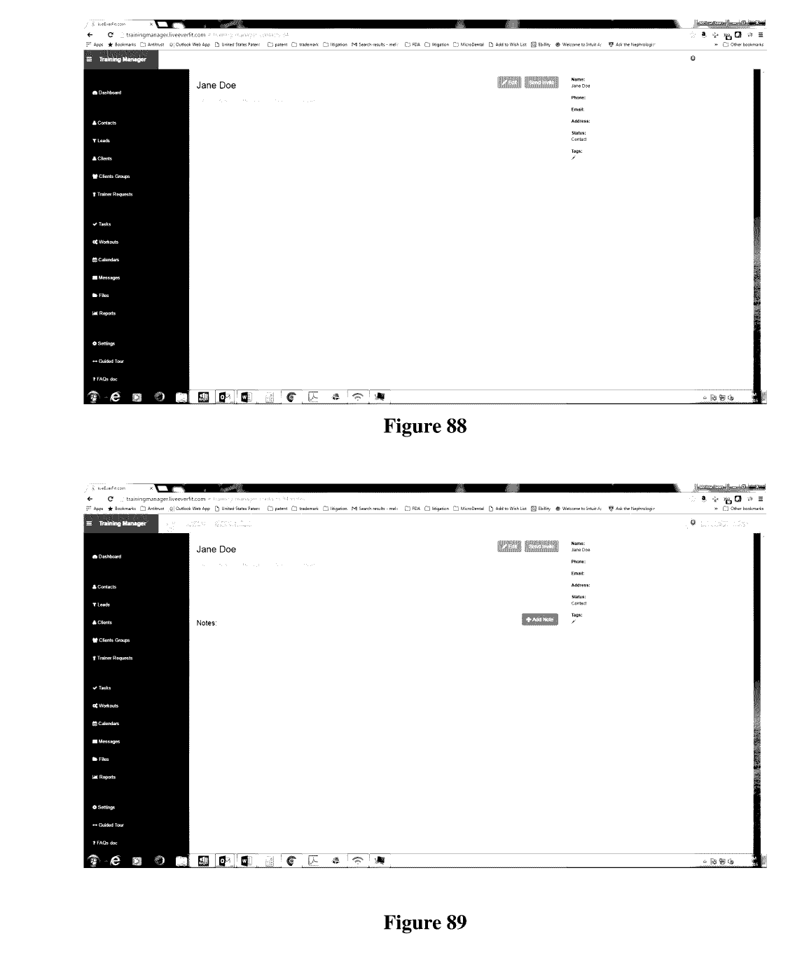

FIG. 88 depicts the entry for an individual contact.

FIG. 89 depicts the Notes for an individual contact.

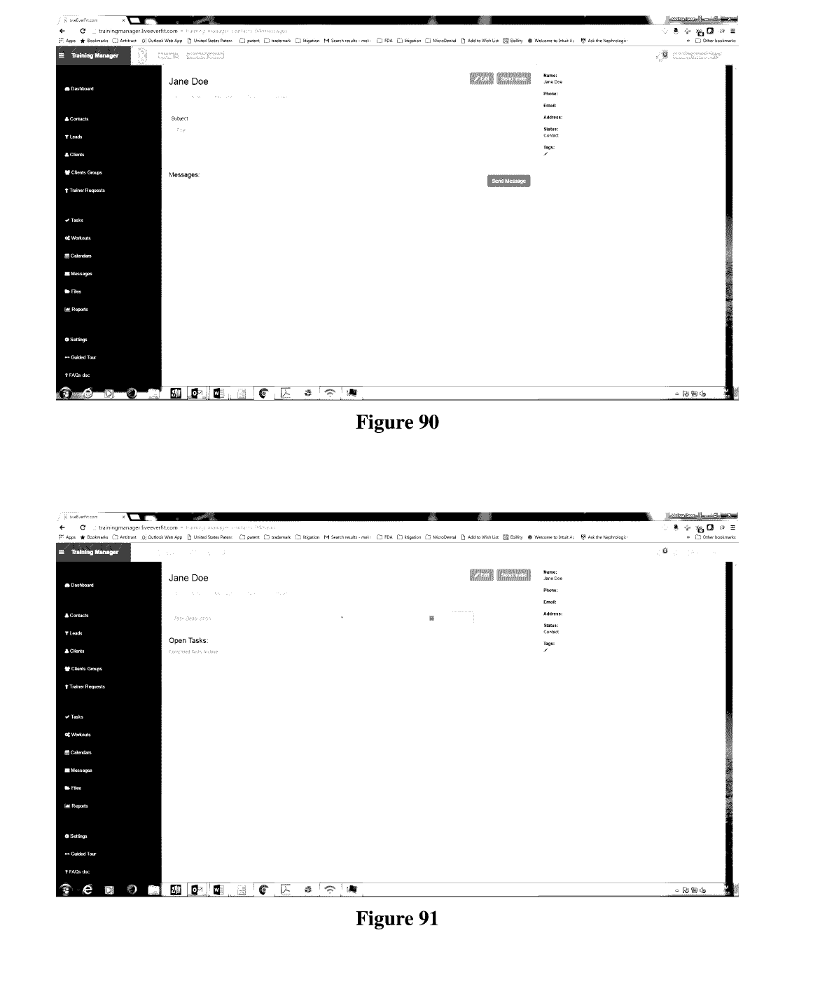

FIG. 90 depicts the Messages for an individual contact.

FIG. 91 depicts the Tasks for an individual contact.

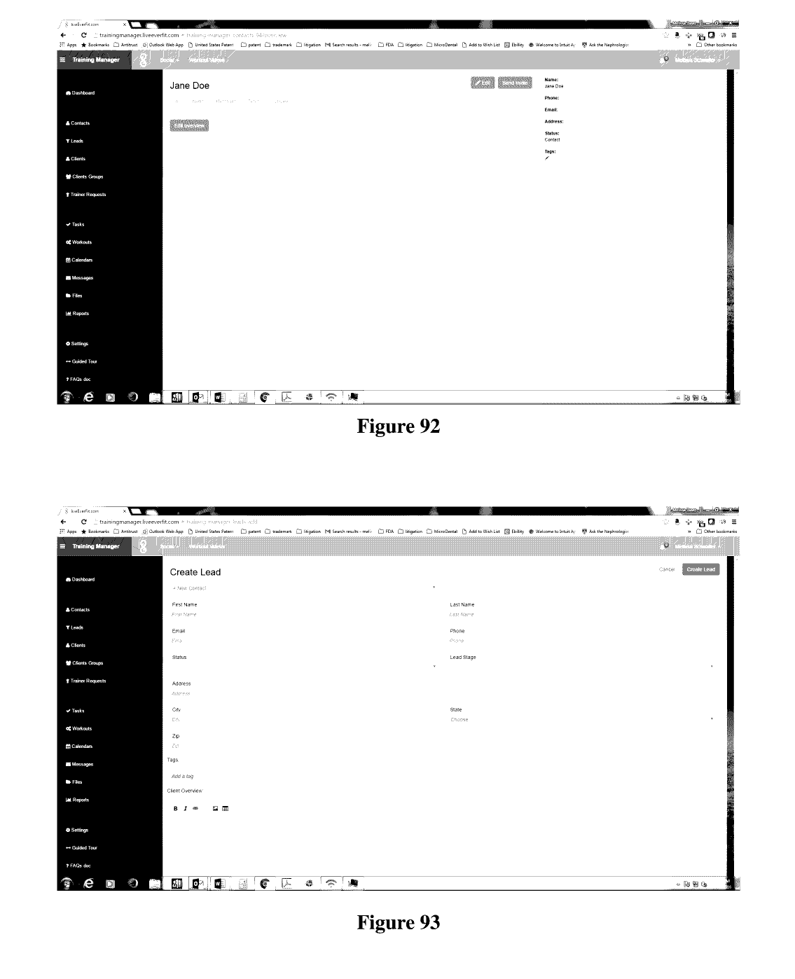

FIG. 92 depicts the Overview for an individual contact.

### Leads

FIG. 93 depicts a Create Lead entry.

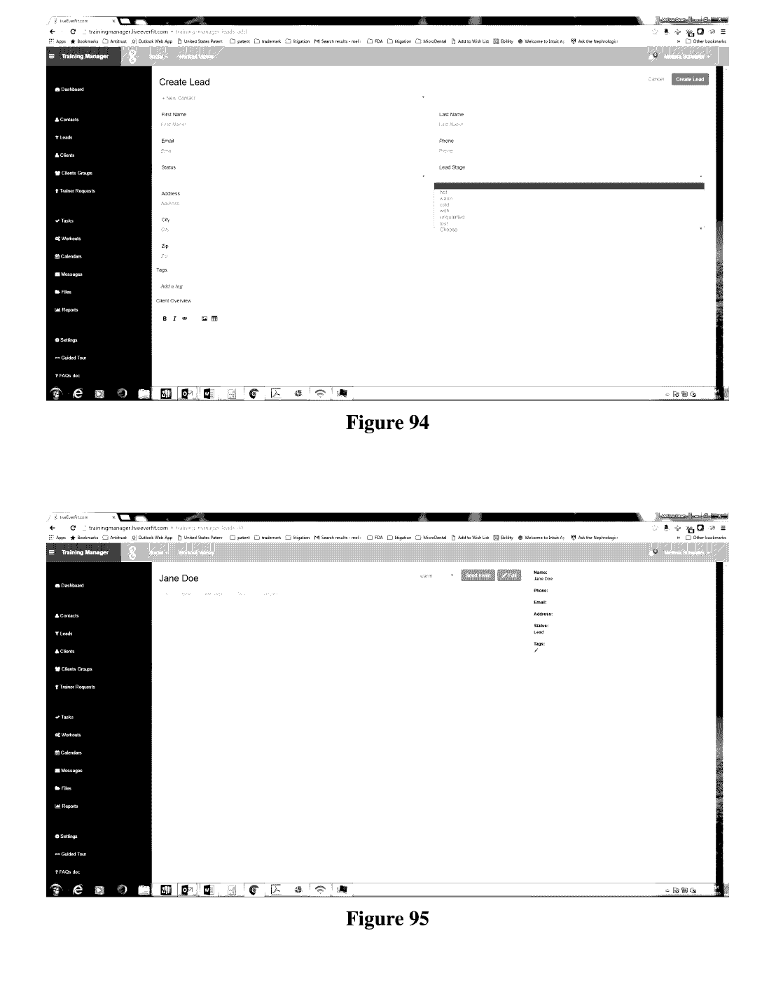

FIG. 94 depicts a Lead Stage for Create Lead entry. In an embodiment, a lead can be characterized as hot, warm, cool, cold, won, unqualified, or lost. In an embodiment, the trainer can indicate how long the individual has been a client or date that the individual became a client.

FIG. 95 depicts a created lead with a lead stage.

### Clients

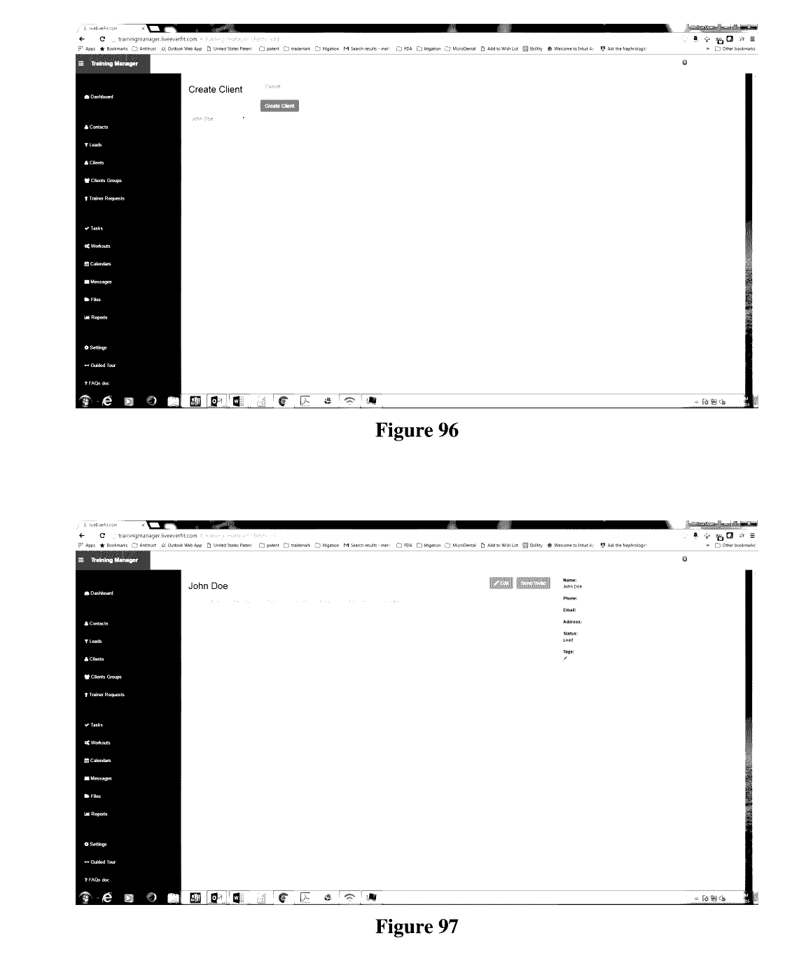

FIG. 96 depicts a Create Client entry. In an embodiment, the client can be switched from lead to client or entered initially as a client. In an embodiment, the trainer can list the fitness goals of the client.

FIG. 97 depicts an individual client entry.

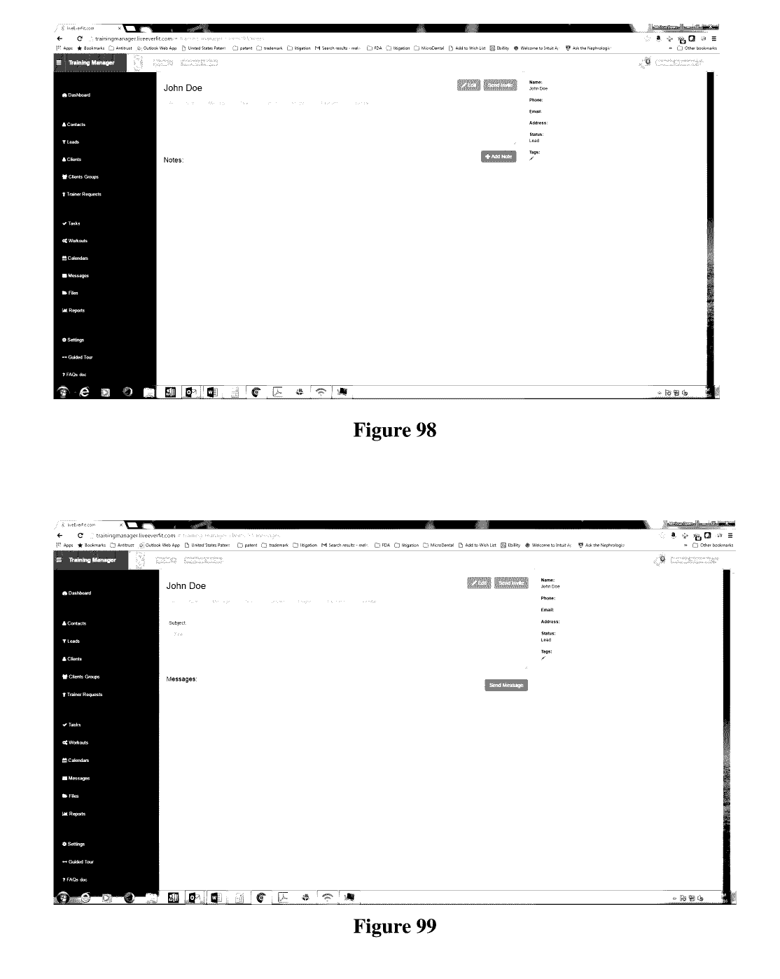

FIG. 98 depicts Notes for an individual client entry. In an embodiment, the Notes can contain information about payment, including but not limited to the rate per hour or the rate per month. In an embodiment, notes are only seen by the trainer.

FIG. 99 depicts Messages for an individual client entry.

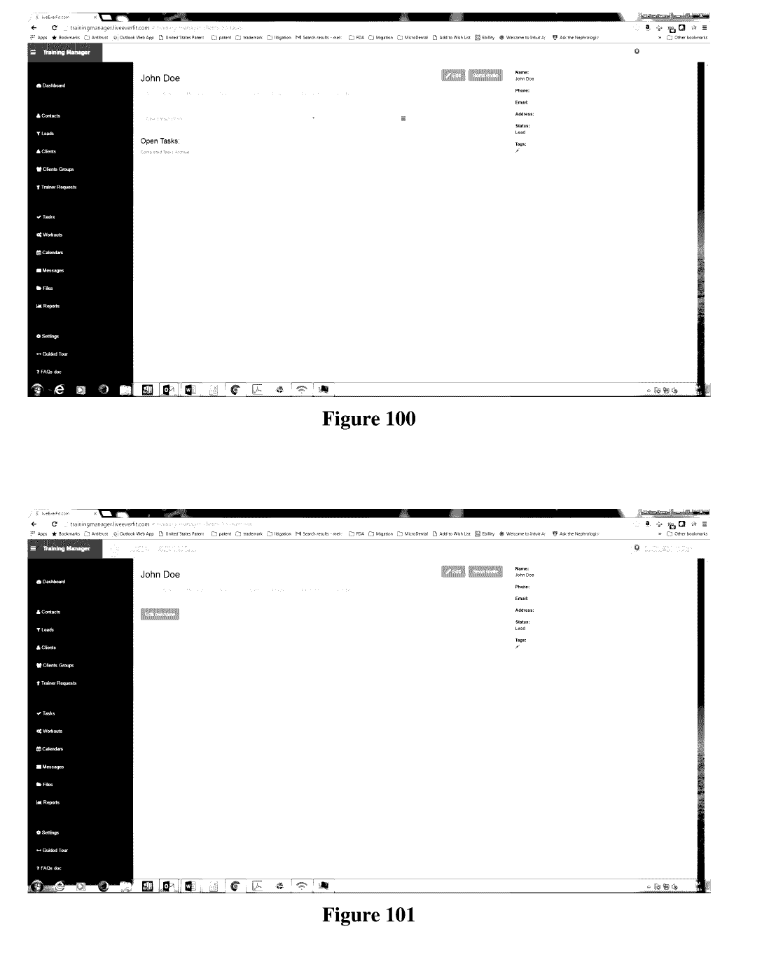

FIG. 100 depicts Tasks for an individual client entry.

FIG. 101 depicts Overview for an individual client entry.

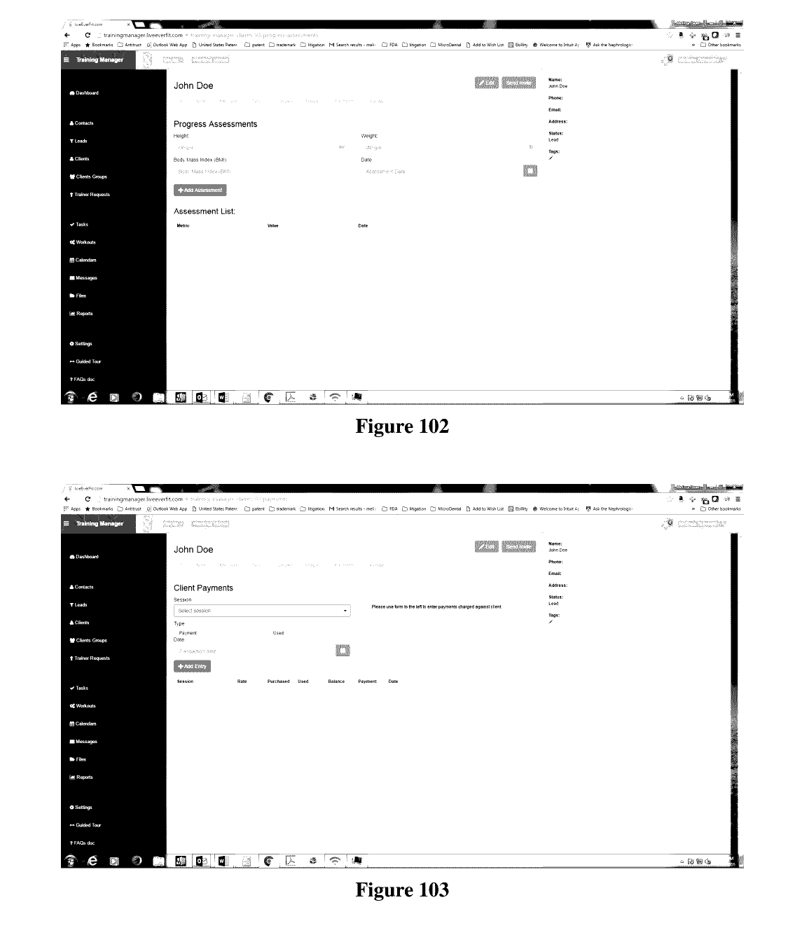

FIG. 102 depicts Progress for an individual client entry.

FIG. 103 depicts Payments for an individual client entry. In an embodiment, the trainer will be able to invoice and receive payments from the client. In an embodiment, the invoice is automatically generated and sent. In an embodiment, the client pays by auto-pay.

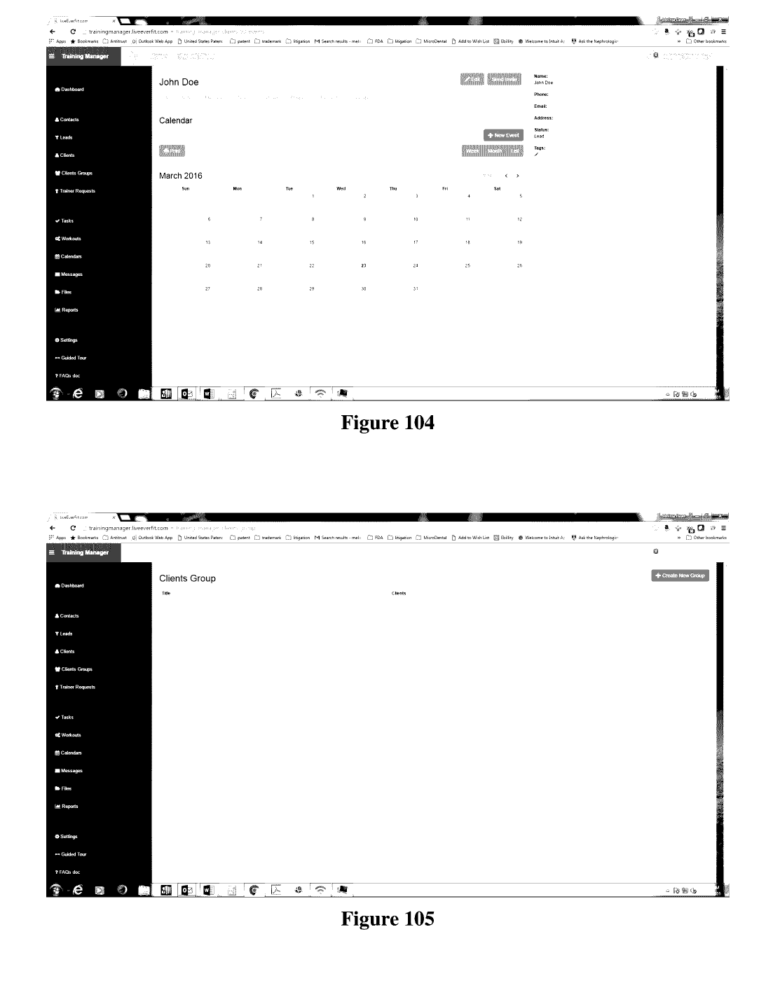

FIG. 104 depicts a Calendar for an individual client entry. In an embodiment, the trainer can add a workout to the calendar for an individual client or group of clients. In an embodiment, the trainer can schedule a reminder to be sent based upon calendar entries. In an embodiment, the trainer can enter information regarding the content of the scheduled session. In an embodiment, the trainer can add a workout to the calendar for the client from the trainer's database of workouts. In an embodiment, the workout can be drag and dropped to the calendar.

### Clients Groups

FIG. 105 depicts the Clients Group. In an embodiment, various clients can be group together based upon including but not limited to interest, skill level, or geographic location. In an embodiment, an email can be sent to a selected group of clients.

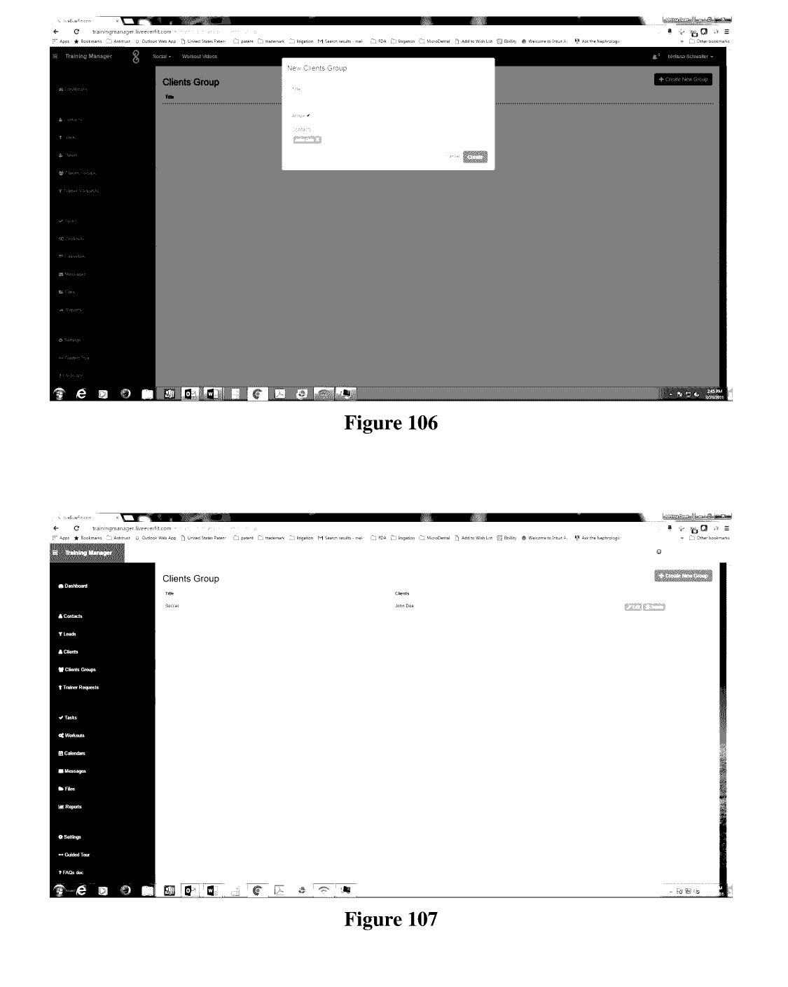

FIG. 106 depicts the creation of a New Clients Group.

FIG. 107 depicts the Clients Group with an entry.

### Trainer Requests

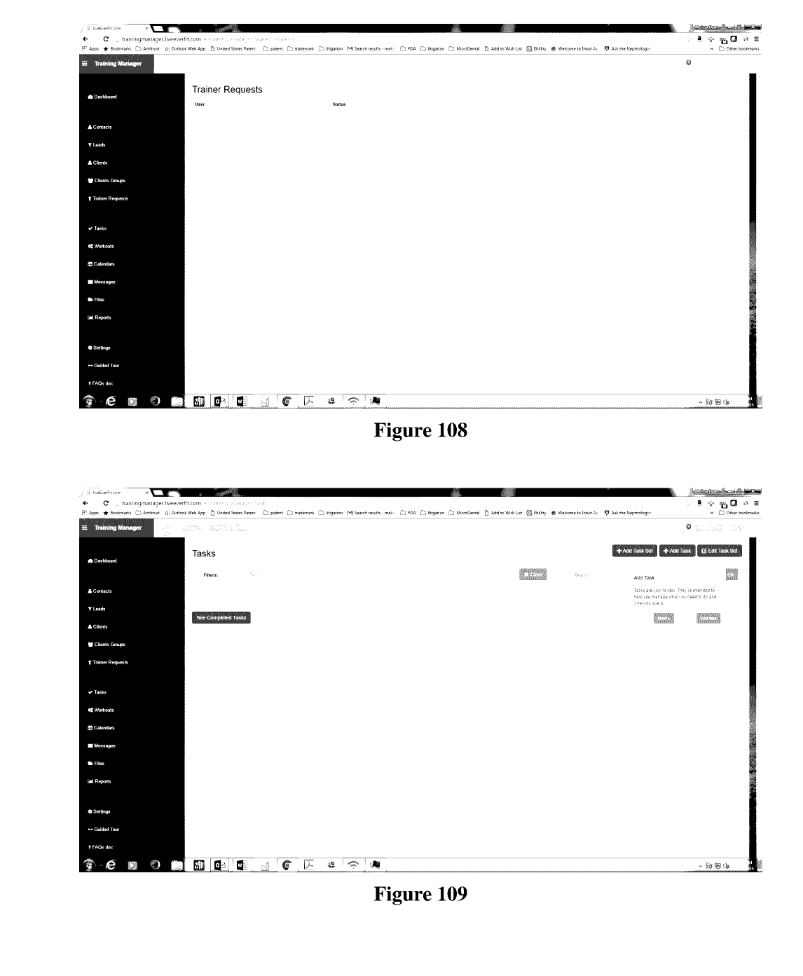

FIG. 108 depicts the Trainer Requests. In an embodiment, when an individual is contacting the trainer for his/her services, the message will be listed here. In an embodiment, the trainer converts the status of the individual to lead or client.

In an embodiment, the sections Dashboard through the Trainer Requests are visible to the trainer and the client.

### Tasks

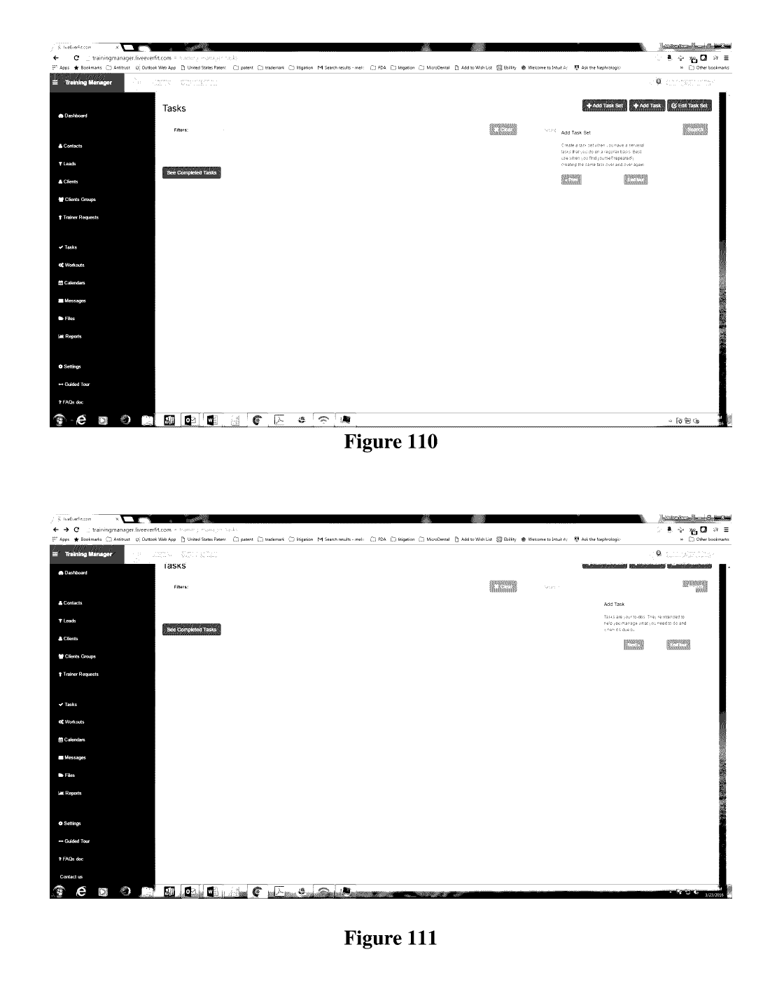

FIGS. 109-111 depict a guided tour of Tasks.

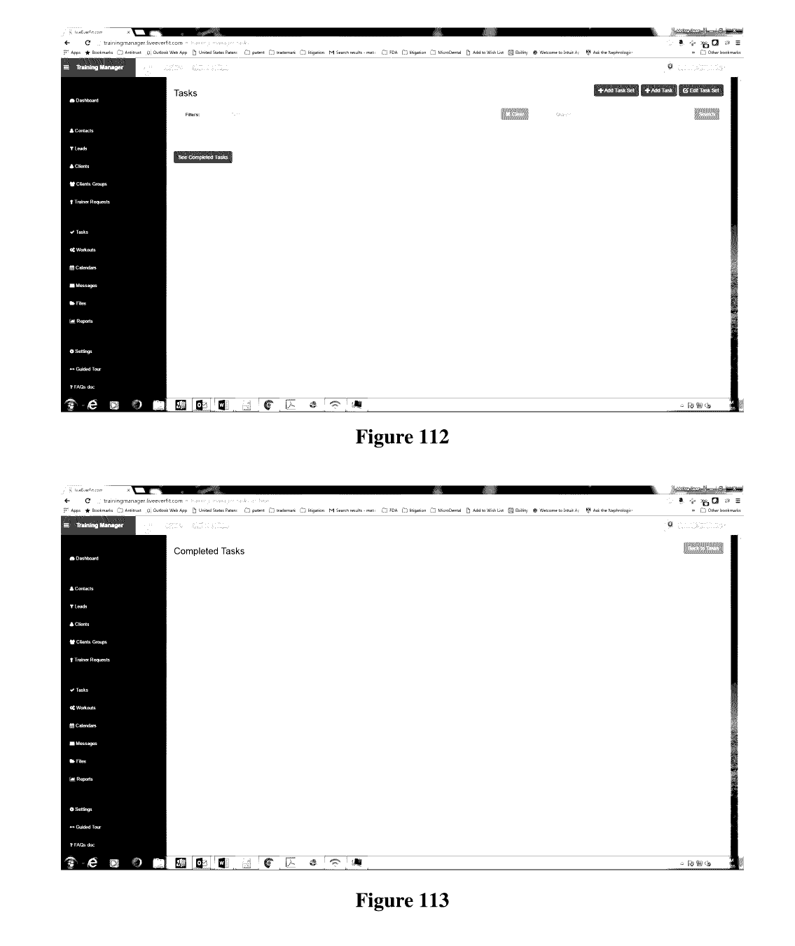

FIG. 112 depicts the Tasks section. In an embodiment, a trainer can enter tasks.

In an embodiment, the trainer can view which tasks have been completed. FIG. 113 depicts the Completed Tasks section.

### Workouts

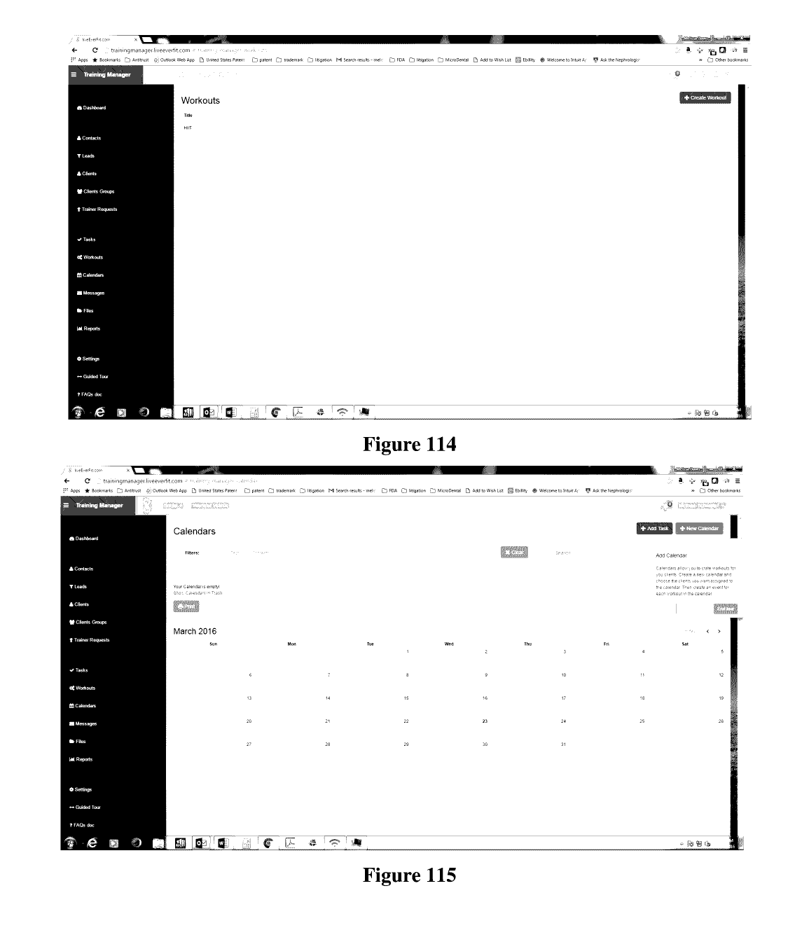

FIG. 114 depicts the Workouts section. In an embodiment, the trainer can input various workouts. In an embodiment, the trainer can select from the workouts to assign to a particular client. In an embodiment, the trainer can drag and drop a workout to place it on the calendar for a particular client. In an embodiment, the trainer can have a full database of workouts. In an embodiment, the workout from the database can be customized for each client.

### Calendar

FIG. 115 depicts the Guided Tour for the Calendar section.

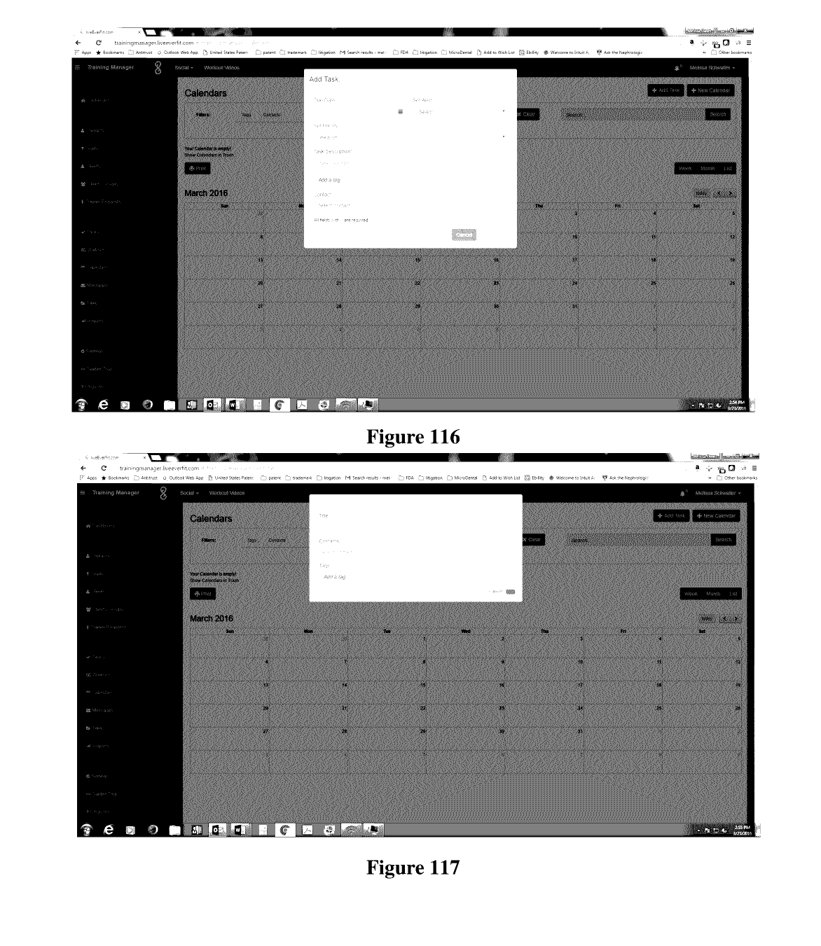

FIG. 116 depicts adding a Task to the Calendar.

FIG. 117 depicts adding a New Calendar entry to the Calendar.

### Messages

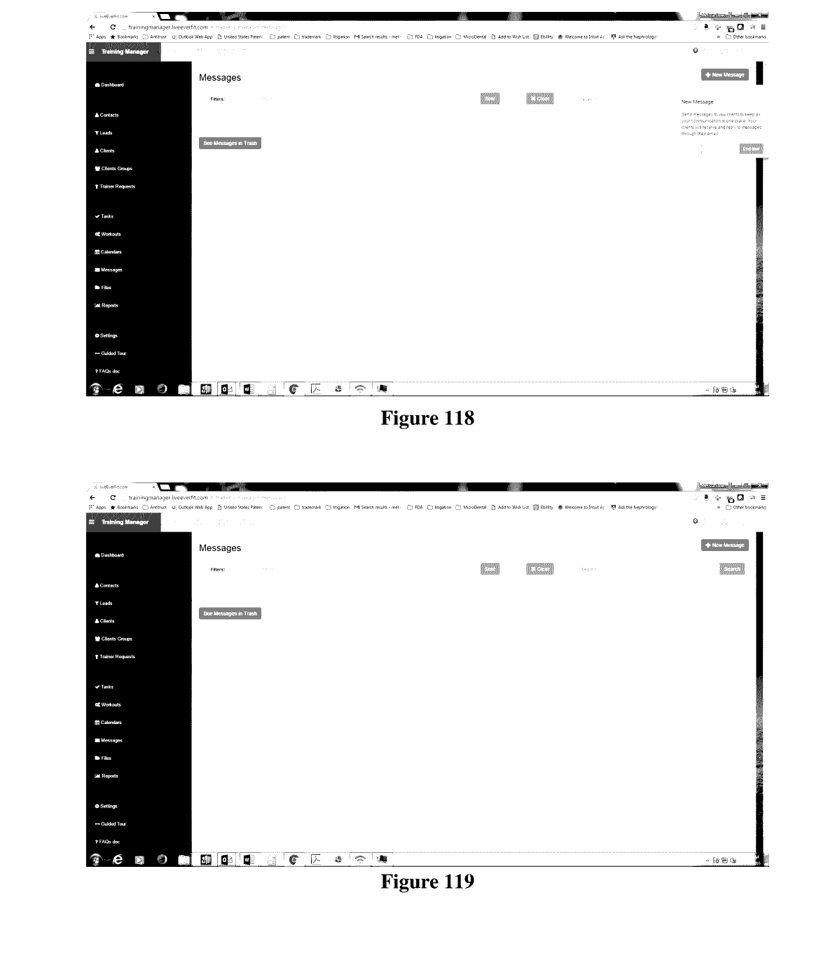

FIG. 118 depicts the Guided Tour for the Messages section.

FIG. 119 depicts the Messages section. In an embodiment, the messages will populate like an inbox on an email client.

### Files

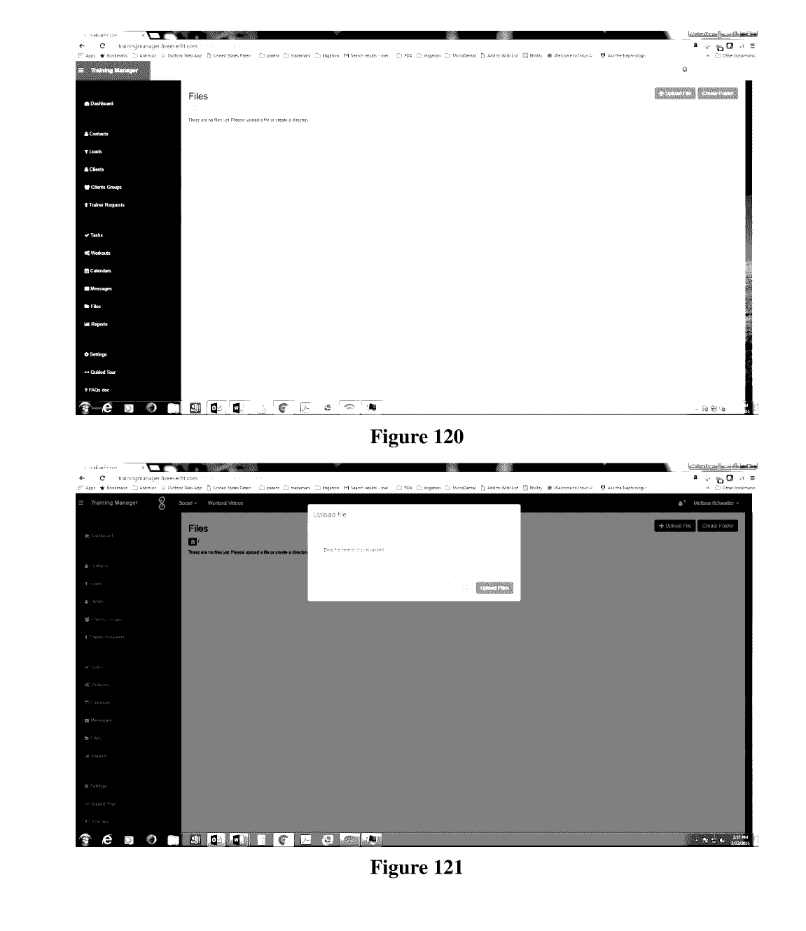

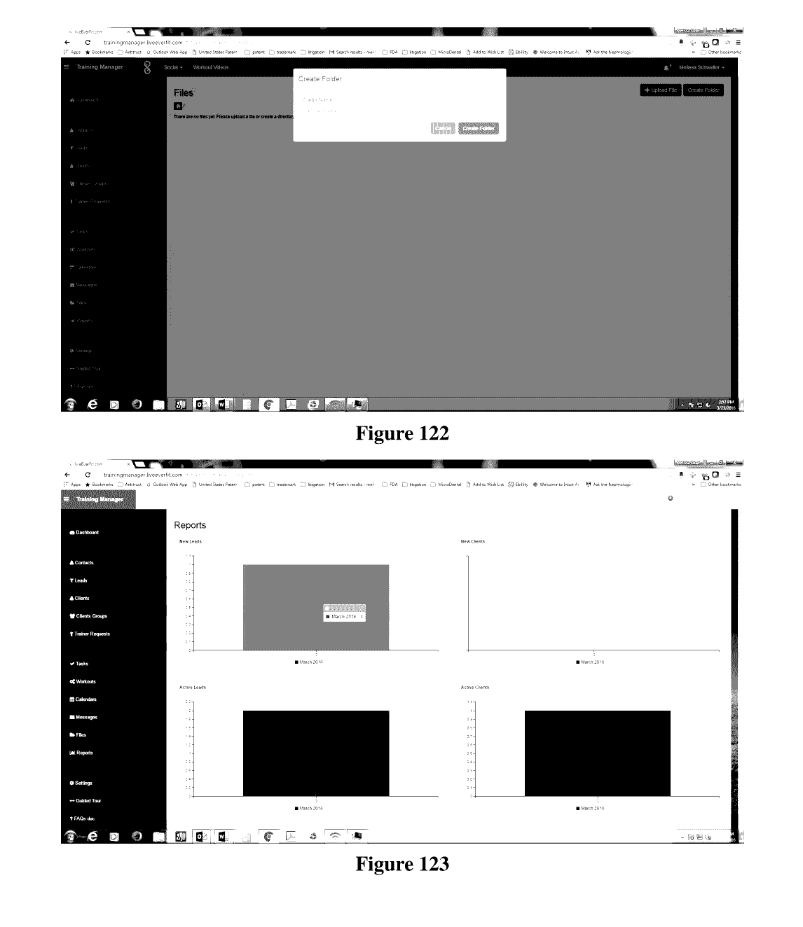

FIG. 120 depicts the Files section. In an embodiment, the trainer can upload including but not limited to pictures, videos, or documents. In an embodiment, the Files section can be used as file sharing. FIG. 121 depicts a mechanism for uploading a file. FIG. 122 depicts a mechanism for creating a folder.

### Reports

FIG. 123 depicts the Reports section. In an embodiment, the reports can include graphs for including but not limited to new leads, active leads, new clients, and active clients. In an embodiment, the reports are by month.

### Settings

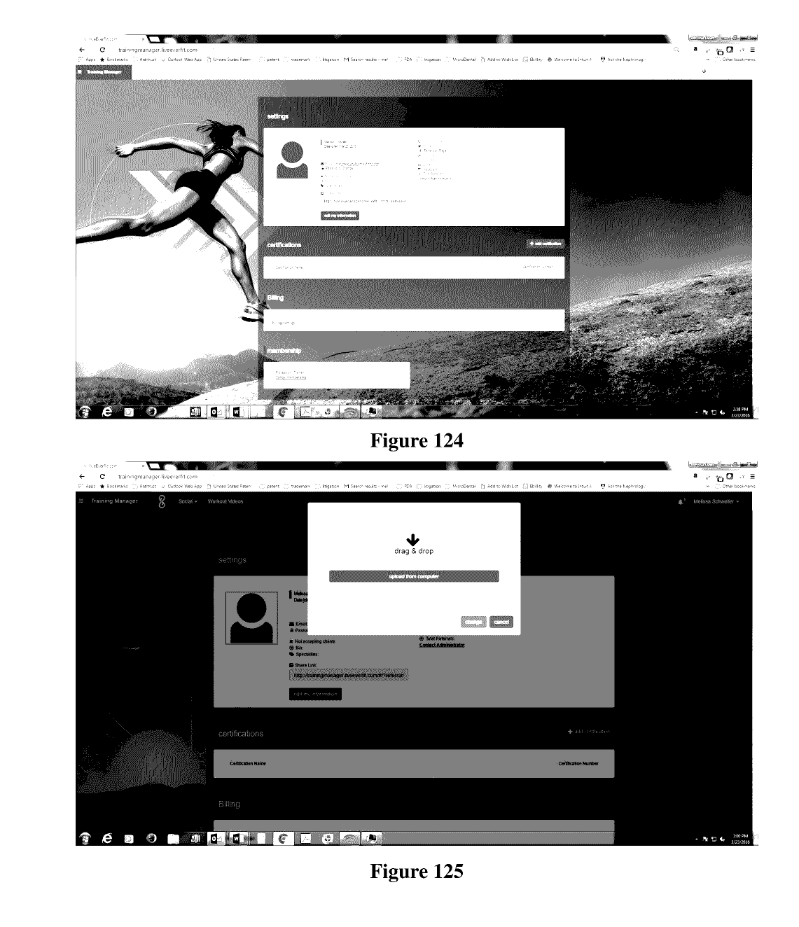

FIG. 124 depicts the Settings section. In an embodiment, the trainer can enter including but not limited to a picture, a biograph, their email address, a password, a web address, specialties, phone number, Twitter username, Facebook address, a YouTube address, a Google+ address, a LinkedIn address, an Instagram address, and total referrals. In an embodiment, the trainer can list his/her certifications. FIG. 125 depicts a mechanism to drag and drop a picture.

### Guided Tour

In an embodiment, the Guided Tour can be accessed through this portion of the menu.

### Frequently Asked Questions

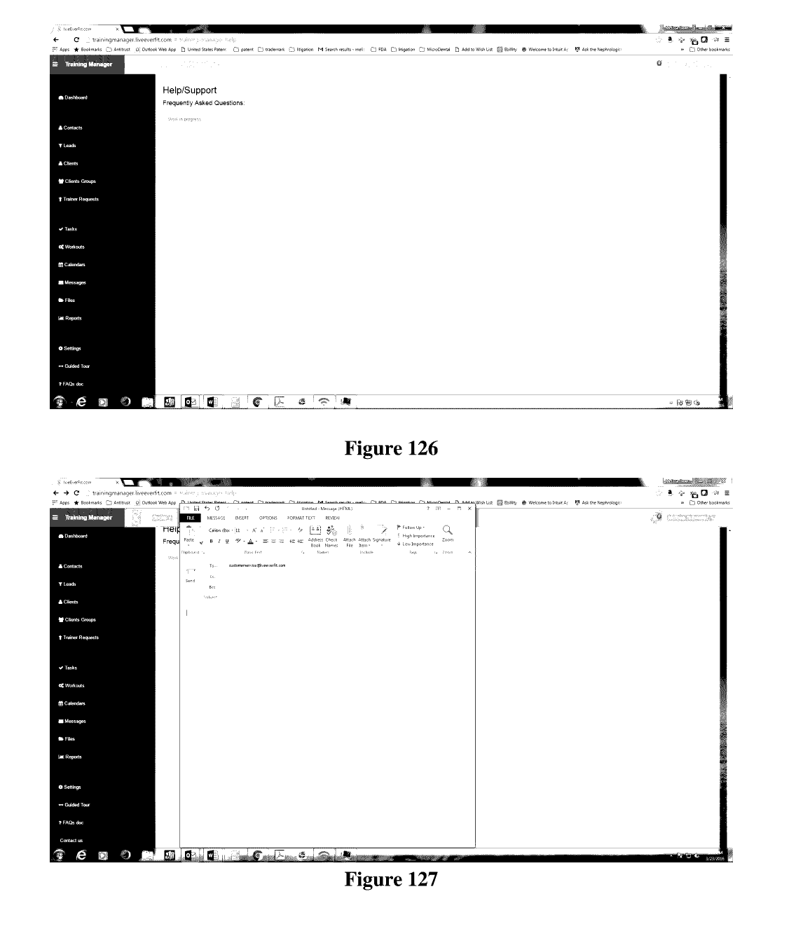

FIG. 126 depicts a section for Frequently Asked Questions.

### Contact Us

FIG. 127 depicts a method to contact customer service. In an embodiment, an email message with the email address entered will open.

In an embodiment, the sections Tasks through Contact Us are visible only to the trainer. The sections Tasks through Contact Us are not visible to the client.

### Additional User Functionality

Client/Pro Management Software: All professionals will have the ability to upgrade their membership from member to Professional for free. They will also have the option to gain access to the Official Client Management Software, for a monthly membership fee. This subscription will be ACH on a monthly basis until the professional decided to cancel.

The CMS offers the trainer 4 main benefits:

1. The ability to handle more clients efficiently by using our preloaded workout library and nutritional information database to build nutritional plans and workouts.
2. Easy drag and drop functionality allows the pro to pull from our database easily to create the workouts and meal plans and then “DROP” the clients workout or nutritional plan in their “FIT BOX”
a. The “FIT BOX” is real time folder similar to a mail box. The users FIT BOX is automatically updated when the Professional drops the workout or nutritional plan “FILE”.
b. With each “FILE” dropped will be the ability to comment and rate the professionals performance with 1-5 dumbbells.
c. With each “FILE” dropped will be the ability to send a written review of the trainer's performance.
   i. This performance rating will be automatically posted to the “PROFESSIONAL RATINGS” page attached to the professional's profile.
   ii. The ability to delete a negative/positive comment can be achieved via sending a rebuttal to the customer service team for review. Once approved, the rating will be deleted.
      3. “Walk through Workout” software displayed via mobile device or desktop computer when the user STARTS the prescribed workout.
a. The instructional video will display with the ability to skip.
b. The rep count will begin in 5, 4, 3, 2, 1 START.
c. The screen will display and voice the prescribed reps. (ability to mute)
d. When completed the user hits next to begin the next exercise.
e. When the user is completed, they will select “UPDATE MY PRO” which will send a text or email to the user's professional.
   i. Comment box attached for user to describe how they feel
   ii. The trainer can immediately respond via text or email to “cheer on” the user.
   iii. 1 on 1 attention ensures that the user is motivated and satisfied with their Pro and continue to renew their training subscriptions.
      4. Instantly update and comment on user's progress or questions via “LIVE CHAT” on mobile device and desktop computers.

In an embodiment, the CMS will contain a FIT BOX. In an embodiment, the CMS will not contain a FIT BOX.

The CMS Nutritional database contains over 80,000 products with all nutritional information. The professional has the ability to “BUILD A MEAL PLAN” from the database. The professional can enter the user's sex, height, weight, and macronutrients. The professional can also choose not to enter the macronutrients in which the software will provide the recommended macronutrient for the user profile information they have entered. Upon selecting food, and liquids with standard measuring units for each selected meal #1-#8 (optional) the professional can view real time macronutrients and calorie totals as they build the meal plan.

When completed the user can title the MEAL PLAN, add additional instructions including duration. The duration/start date/end date can be entered and will reflect on the Users Calendar automatically upon approval from the user. The completed meal plan is then DRAGGED and DROPPED into the users FITBOX.

The CMS Workout database contains over 1000 individual exercise instruction videos on full start to finish movement. The professional has the ability to “BUILD A WORKOUT” with DRAG AND DROP features as mentioned above. The professional has the ability to search the workout DATABASE and drag individual workouts to “THE PLAN”. The search option contains preloaded plans with the ability to add more. In an embodiment, the preloaded plans are Male strength building, Female strength building, Male weight loss, Female weight loss, Male agility/sports training, Female agility/sports training, Male muscle building, and Female muscle building. The search option contains individual exercises with the ability to add more. In an embodiment, the individual exercises are searchable by Body part, Push/pull, and Stretching. Once the exercise is dropped into the plan the professional can edit the reps and sets, add additional instructions, and save. When completed the professional can title THE WORKOUT PLAN and add additional instructions including duration. The duration/start date/end date can be entered and will reflect on the User's Calendar automatically upon approval from the user. The completed workout plan is then DRAGGED and DROPPED into the users FITBOX. The professional is alerted via text/email when the user has opened THE PLAN. The user is alerted via text/email when the professional has dropped the plan into the users ‘FIT BOX’. The user and professional can edit their communication preference via their settings. The professional can ACTIVATE “GET MOVING” updates directly to the user's phone via text or email. The user must approve the ACTIVATION. GET MOVING is an “ALARM” style alert that challenges the user to get moving with small 30 second challenges. In an embodiment, the 30 second challenge is Squats for 30 seconds, Sit ups for 30 seconds, or Toe touches for 30 seconds. The get moving alerts “text” the user with an immediate “START” and “COMPLETED” button to immediately alert the professional of the completion. The GET MOVING is solely for an additional motivation to change the users lifestyle to more healthy and active tasks through the day for overall health improvement.

### Transformation Showcase Video

The user and professional have the ability to create a real time lapse video to showcase their own transformation or a user's transformation. This feature further promotes the professional's training results or the users encouraging transformation. To create the time lapse folder the user can drag and drop photos from their current system photo album. The users/professional can also upload photos from a mobile device or desktop computer. In an embodiment, 5-30 photos must be selected; when the user/professional selects “Create my video” the time lapse move aligns the human figure in the pictures to more accurately line them up; when the video is completed it will be stored to the “TRANSFORMATION” tab on the users/professionals profile; and the user/professional has the ability to share to the system community, share to external social media (Facebook, Twitter, LinkedIn), and email via link. The LiveEverFit Team will have quarterly “TOP TRANSFORMER CONTEST” to showcase the users/professionals achievement. The winner will be chosen based on the biggest transformation and win a credit to the Store to keep up on their achievement. In an embodiment, the credit amount is $500.

### Personal Live Streaming

The accomplished professional has the option to feature “LIVE STREAMING” to our audience. The professional will be reviewed and either approved or denied the ability to use the live streaming feature. Live Streaming video will give the professional the opportunity for additional earning via commission from users purchasing class credits.

Commission structure is as follows: System 60%/Professional 40% of each attendee's class purchase. The commission earned will be paid out within 10 days of months end. As a professional featuring LIVE STREAMING they will have the ability to schedule their classes via the Live Streaming Calendar. The professionals own classes will only display on their personal calendar. The Streaming Calendar will display based on day, week, and time and class type. In an embodiment, class types range from kickboxing, yoga, cross fit, cooking classes, education webinar, and others. The professional will be provided web login information to sync their web camera to the live streaming class schedule. As a user, classes are searchable by day, week, type, class type, and class level (beginner, intermediate, advanced, credit level). Credit Level: Each professional has the ability to charge 1-3 credits per class based on the professional's discretion. Once a class is selected the user is prompted to purchase credits. In an embodiment, the Credit Packages are 1 credit: $1.99; 5 credits: $8.99; 10 credits: $17.99; and 30 credits: $55.99. The user's credit balance will show after each class purchase. Once class is purchased and RSVPed the user will receive access to the class. No credit will be given for missed classes to which the user RSVPed. No credit will be given for late class purchase (all ready in session). The professional may add any additional class information for the user to view before purchase. The professional has the ability to SHARE their class schedule: via External social media (Facebook, Twitter, LinkedIn); system newsfeed; and Email. Users who purchased the class have the ability to send “COME WITH ME INVITES” to their friends via text/email.

### Gym Streaming

Professional establishments have the ability to LIVE STREAM their group fitness classes via the system website. The gym must apply and be approved for the ability to purchase the System Streaming Camera. The camera comes completely assembled with “face blurring” technology. The face blurring technology blurs out all faces in the class minus the instructor. This alleviates the need to have every attendee sign a release form. The camera is then installed by the gym or by the system-contracted installation team at an additional cost. Once the camera is placed and tested the gym may add classes to their system profile to be scheduled in the Live Streaming Calendar. The commission structure is as follows: System: 50%/Gym: 50% of each attendee's class purchase. The commission earned will be paid out within 10 days of months end. At the class scheduled start time, the gym will be required to “START” Live Streaming. The live streaming will continue until the gym selects “STOP” Live Streaming. The gym has the same functionality to schedule and share the class calendar. The gym will be provided web login information to sync their web camera to the system live streaming class schedule. As a user, classes are searchable by day, week, type, class type, and class level (beginner, intermediate, advanced, credit level) set by the gym.

### Reach Map

The user/professional have the ability to see the “reach of their network” from the system reach map. When a user/professional accumulates a new referral from the “share link” they have posted or shared, a user icon will populate the system map with their location. The user/pro may click on the icons located on the map to be brought to that individual's profile. Visualizing to the user/professional the “size” of their network across the United States assists in encouraging the user to continually share their “share link” to grow their referral network. Alongside the map will be an open link to view ALL referrals listed by name.

### Mobile

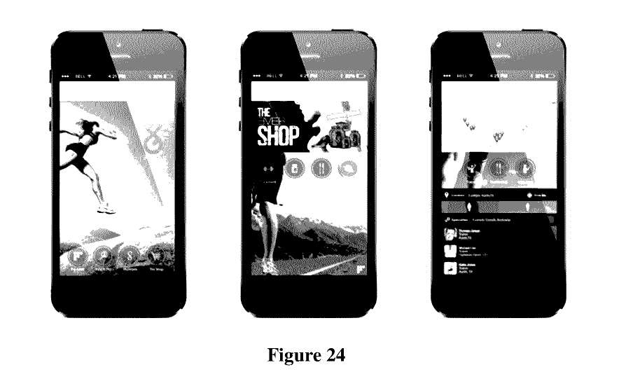

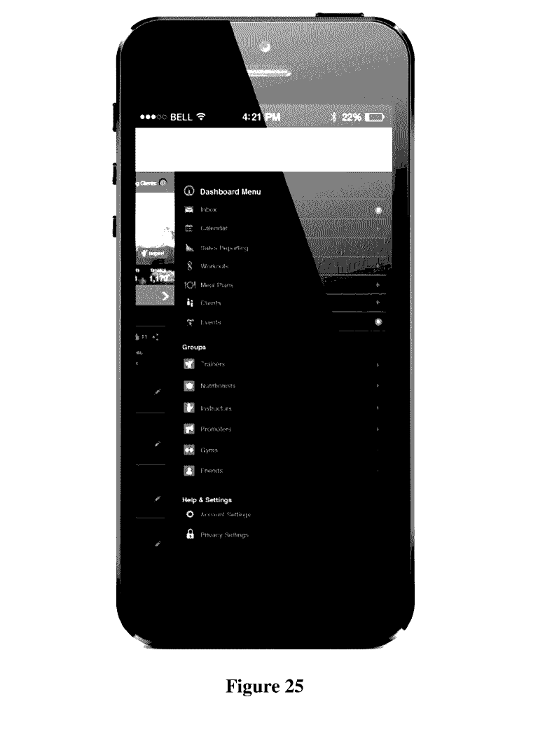

The system and method also can be utilized on a mobile device. FIG. 23, FIG. 24, and FIG. 25.

### Social Section

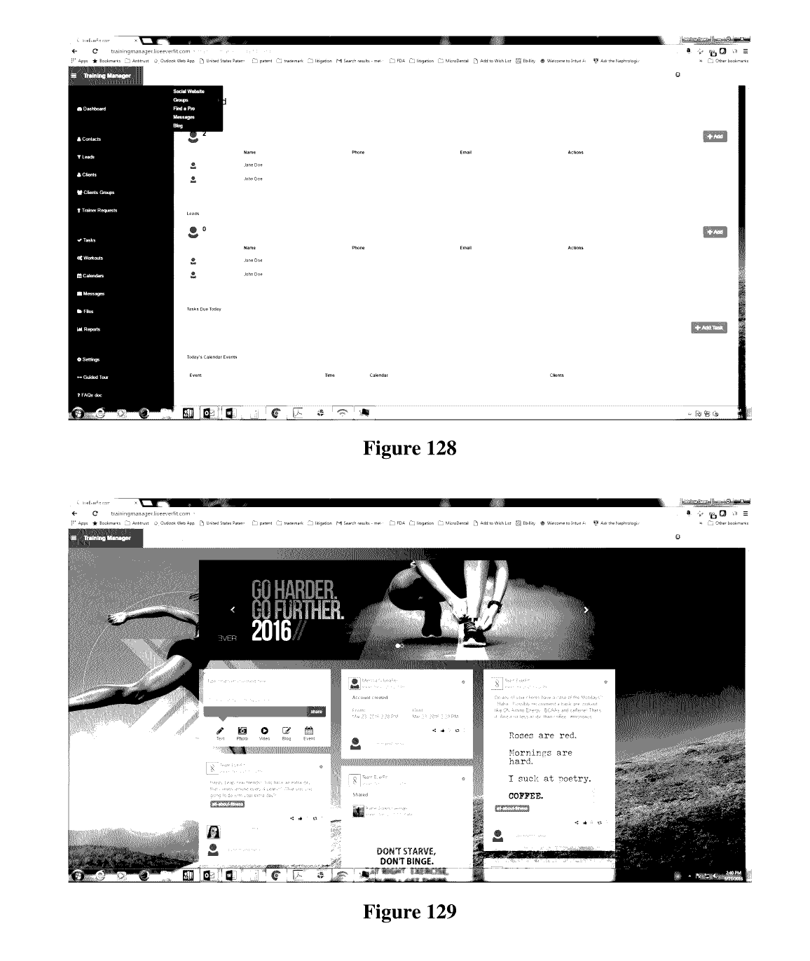

FIG. 128 depicts a drop-down menu of section of the social section. In an embodiment, the menu can include the Social Website, Groups, Find a Pro, Messages and Blog. In an embodiment, the groups are separated by categories. In an embodiment, the categories can be interest, or level of fitness and/or skill. In an embodiment, the groups can be including but not limited to crossfit, soccer, baseball, running, yoga, nutrition, Hiit, upper body, lower body, abs, weight training, beginner, circuits, intermediate, plyometrics, advanced, golf, all-about-fitness, motocross, trx, biking, kettlebell, wakeboarding, surfing, basketball, football, mma, kid-fit, senior-fit, kickboxing, calisthenics, whole body, s-u-p, and disc-golf.

FIG. 129 depicts the Social Website.

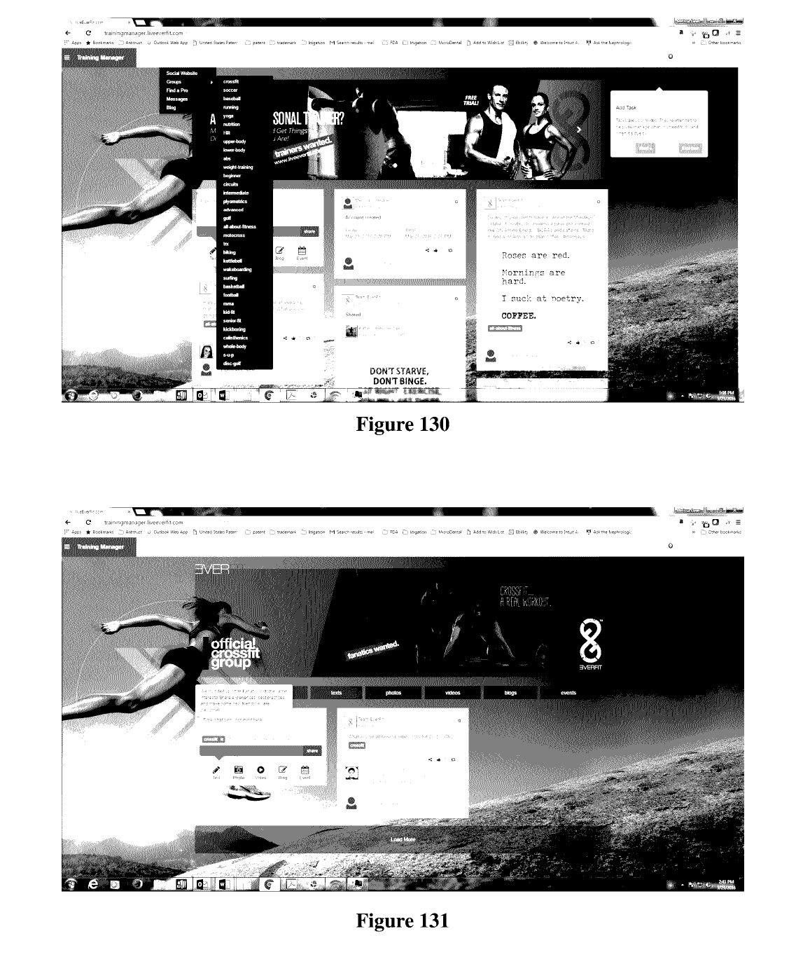

FIG. 130 depicts the listing of groups.

FIG. 131 depicts the crossfit group page.

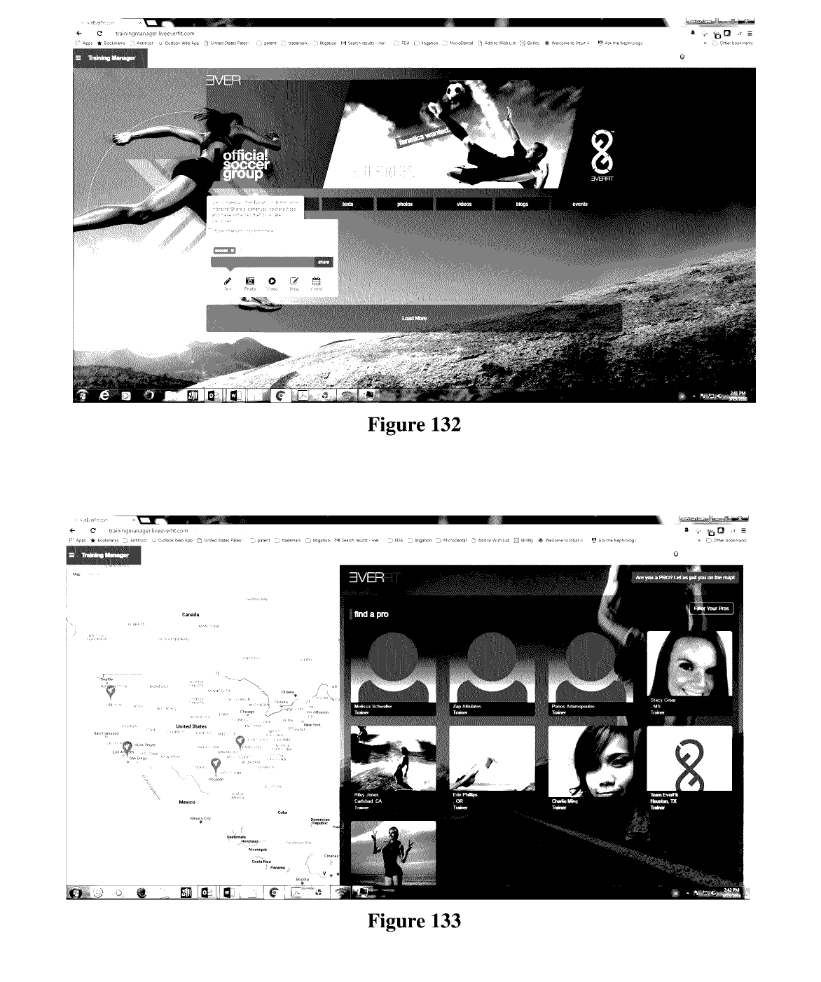

FIG. 132 depicts the soccer group page.

FIG. 133 depicts the Find a Pro section. In an embodiment, a map indicates the geographic location of trainers.

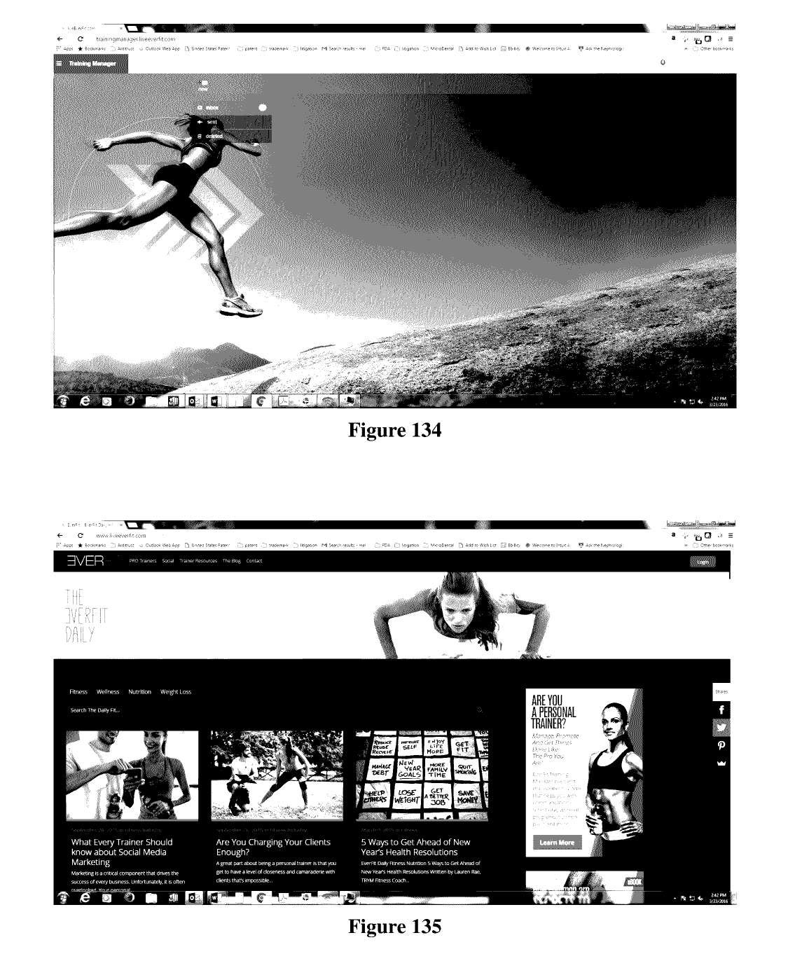

FIG. 134 depicts the messages page. In an embodiment, the page will include an inbox, sent messages, and deleted messages. In an embodiment, a new message can be created and sent.

FIG. 135 depicts a blog section.

### Professional Workouts

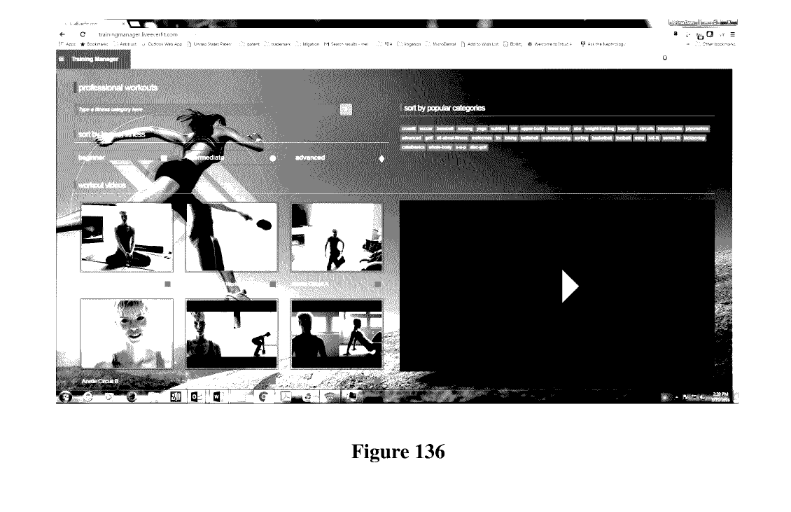

FIG. 136 depicts various professional workouts that can be selected. In an embodiment, the workout is a video. In an embodiment, the workouts can be searched by categories including but not limited to workout type, trainer, and/or level of fitness and/or skill.

### EXAMPLES

### Example 1

### Landing Page

The system is a resource in health and fitness where individuals can obtain direct access to a wide variety of fitness information and a global network of certified professionals ready to help users get on track and keep them there. The Landing Page is shown in FIG. 1.

### Social

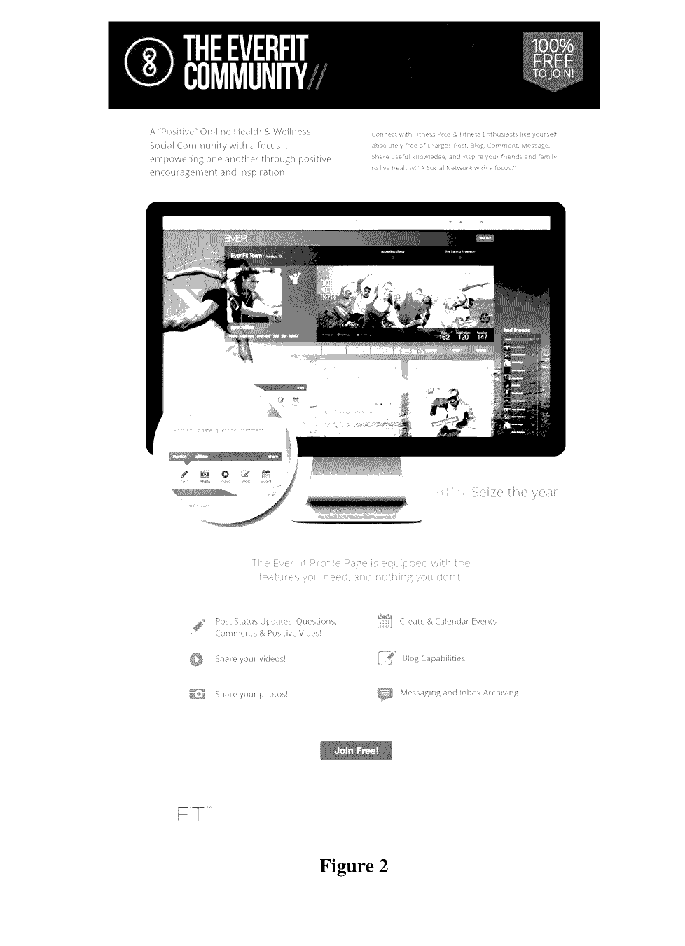

The Community is a Social Network of Pro Trainers, Nutritionists, Instructors, and Fitness Enthusiasts working together towards one goal . . . Living healthy, and inspiring others along the way. The Social Modal is shown in FIG. 2.

A “Positive” On-line Health & Wellness Social Community with a focus . . . empowering one another through positive encouragement and inspiration.

Connect with Fitness Pros & Fitness Enthusiasts free of charge! Post, Blog, Comment, Message, Share useful knowledge, and inspire friends and family to live healthy! “A Social Network with a focus.”

### Find A Pro

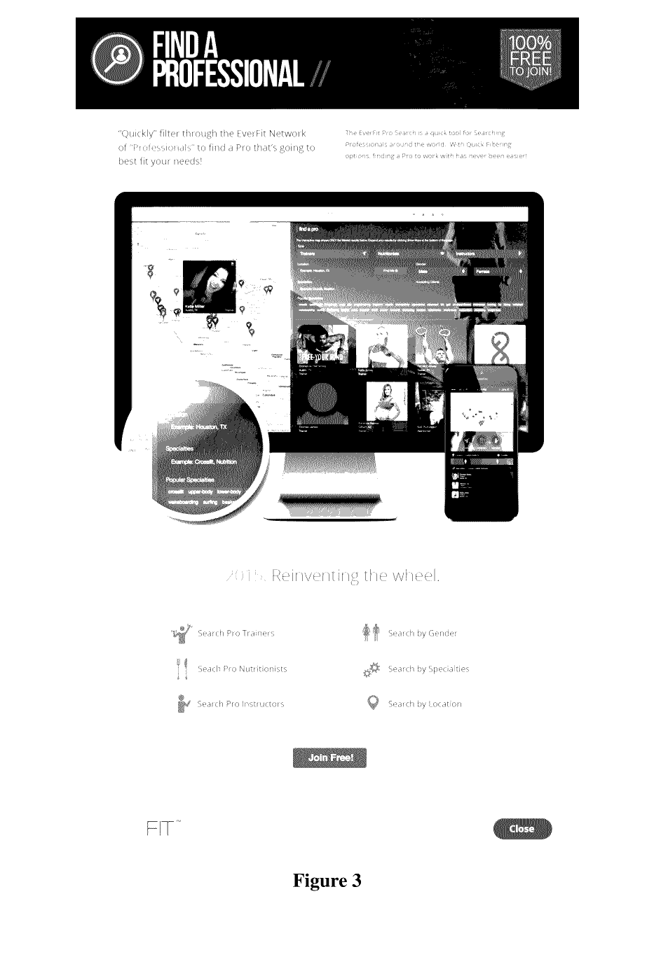

Quickly search and filter through the Network of Pros to find a coach that's going to best fit your needs. The Professionals are passionate about their clients and seeing them succeed . . . failure is not an option in our playbook! “Seize the Year!” The Find A Pro Modal is shown in FIG. 3.

Quickly ““filter through the Network of ‘Professionals’” to find a Pro that's going to best fit your needs!

The EverFit Pro Search is a quick tool for Searching Professionals around the world. With Quick filtering options, finding a Pro to work with has never been easier!

### Professional Workout Videos

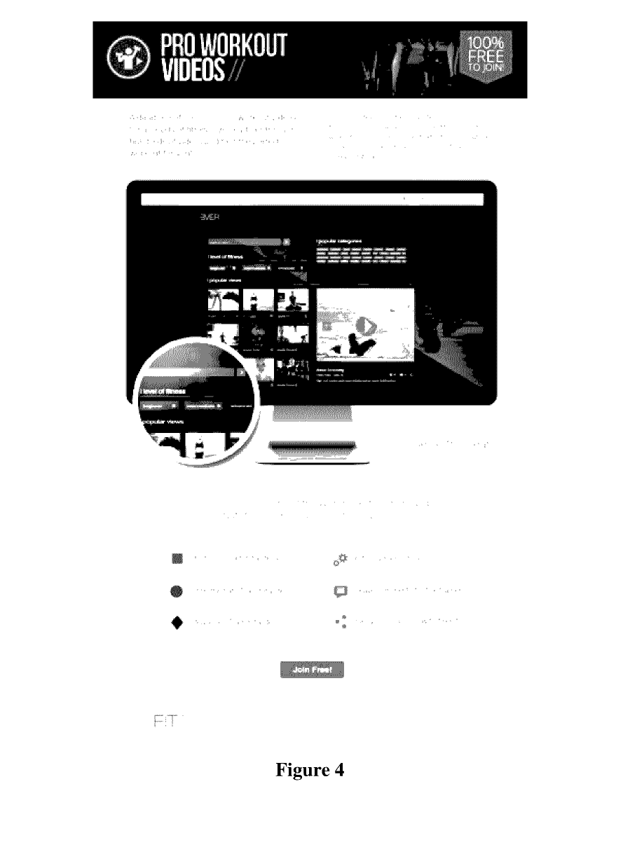

Get access to hundreds of professional, informative, workout and exercise videos to watch at the user's convenience. In an embodiment, novice or expert training is available. The Professional Workout Videos Modal is shown in FIG. 4.

A database of Professional” workout videos are available for all levels of fitness. There is an ability to quickly filter through hundreds of videos to find the perfect workout.

The system includes hundreds of professionally shot videos . . . from the beginner's workouts to some of the toughest workouts for the more advance athlete. There are workouts available for various levels in the Workouts video library!

### Mega Fitness Shop

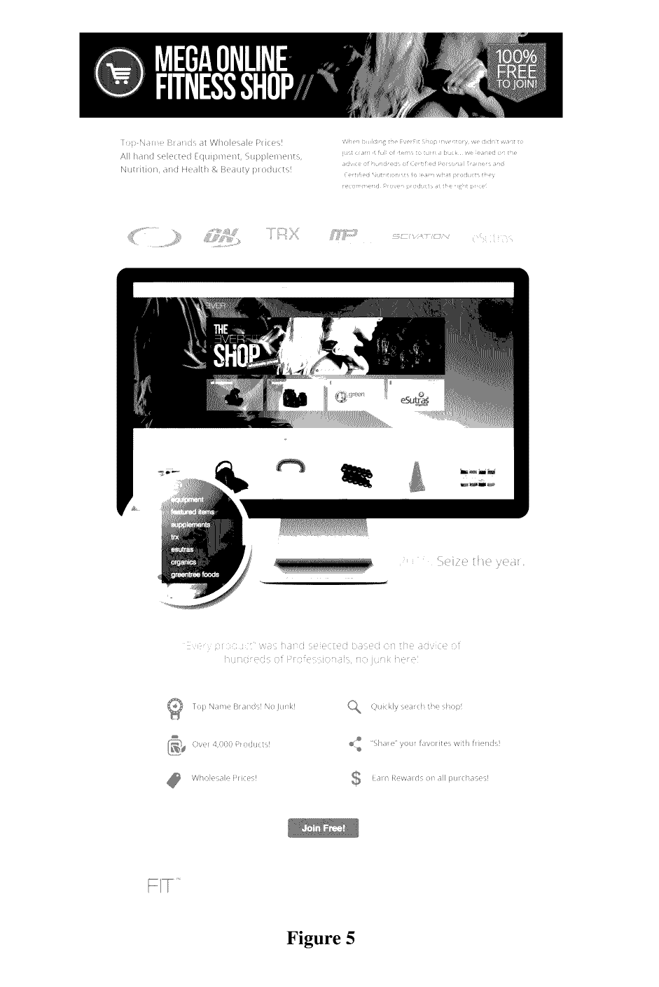

Brands will be available at wholesale prices. Reward Points are earned on all purchases and for “social sharing”. In an embodiment, Equipment, Supplements, Nutrition, and Health & Beauty are available. The Mega Fitness Shop modal is shown in FIG. 5.

When building the Shop inventory, the advice of Certified Personal Trainers and Certified Nutritionists will be utilized to learn what products they recommend.

### Community & Purpose

The system provides a way to keep users motivated toward a healthier lifestyle first, and to then encourage them to pay it forward. The users go from being one who's “being inspired” . . . to the one being an inspiration.

### Example 2

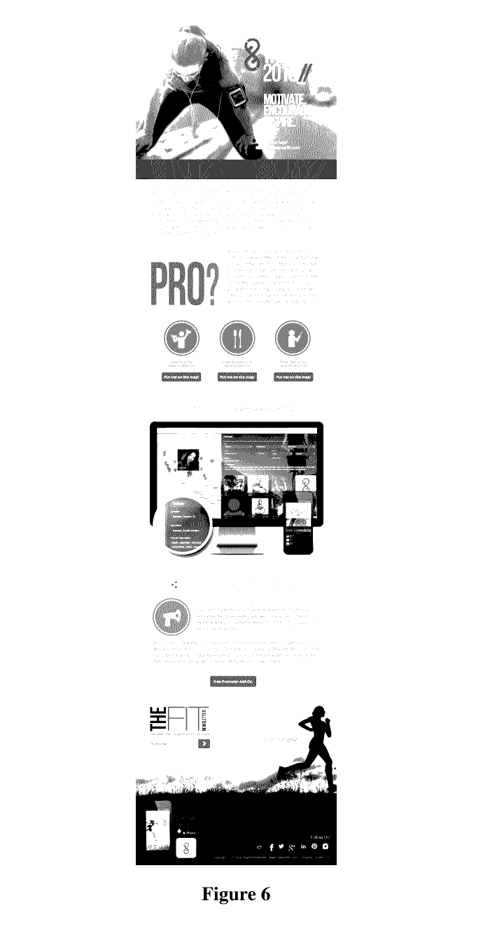

### General Sign-Up Auto-Responder (FIG. 6)

Welcome to the EverFit Network of Professionals!

Outstanding! You're now officially a part of the EverFit Movement! As an Everfit User, we encourage you to post your photos & videos, comments, and questions if you have them . . . we′d love to hear from you! Also as a User, you earn “Rewards” on all your purchases made in the EverFit Shop, and for “Social Sharing” EverFit with friends and family! Now that's pretty awesome! Now Upload you're awesome profile image so we can see that beautiful mug of yours!

Are you a Professional Trainer, Nutritionist, or Instructor? As a Certified Professional, EverFit will put you on the EverFit “Pro Map Search” for free to increase your exposure and help you grow your personal clientele Simply “click” the “Put Me On The Map” button under the Professional Icon you want to rep and we'll put you on the map! Literally! Instructors can be Golf, Tennis, Football, Aerobics Instructors, etc. . . . we love diversity!

Are you a Social Sharing Junkie? If you're not a Professional Trainer, Nutritionist or Instructor, but rather the fitness enthusiasts who simply loves “Sharing” Health & Wellness . . . add the “Promoter” Add-On to your account FREE for a limited time!

All Users earn “Rewards” on all purchases in the EverFit Shop and for “Sharing” EverFit with your peeps, but as a “Promoter”, EverFit will increase your “Rewards Return” for helping us get the word out! We appreciate your passion for Health & Wellness and your efforts letting others know about EverFit! Motivate, Encourage, Inspire!

### Example 3

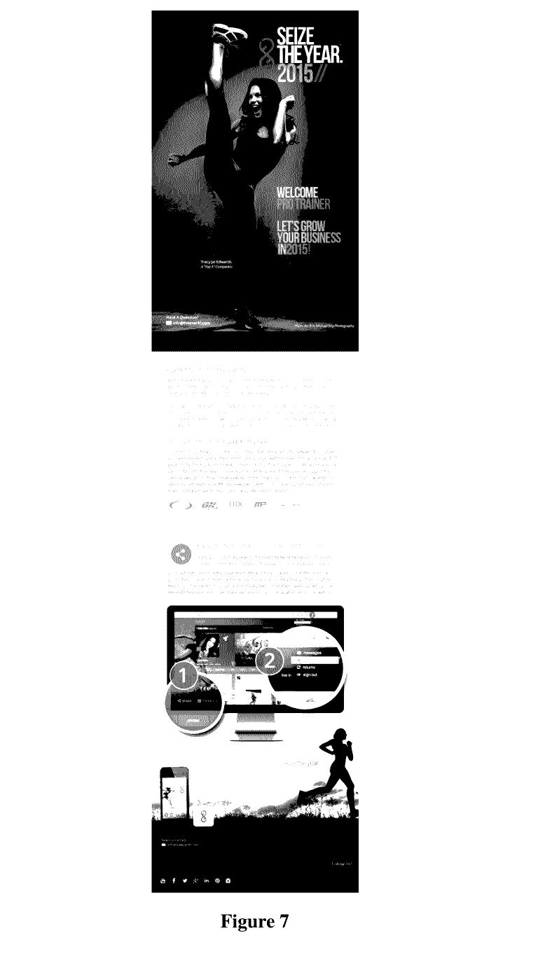

### Trainer Sign-Up Auto-Responder (FIG. 7)

Welcome to the EverFit Network of Professionals!

We're stoked to have you! Your passion for Health & Wellness is inspiring to us all! The World is a better place having your compassion for others and helping them to live a healthy, more fulfilled and confident life. We thank you.

EverFit was created by Trainers & Nutritionists, for Trainers, Nutritionists, and your potential clientele. EverFit a “positive” environment to increase your personal clientele and encourage Health & Wellness while inspiring one another along the way. Much love and appreciation for helping us grow something “good” for all of us to learn and grow from. Live Everfit!

The Benefits of the EverFit “Trainer”. In addition to putting you on the EverFit Map, EverFit has a built in a Rewards Program you can leverage to put a little something in your pocket! The EverFit Shop has over 4000 products by the Top Name Brands in their industry: TRX, Gaspari, On, MusclePharm, Scivation, NES, eSutra Organics, and much more! As an EverFit Pro you can suggest the same quality products you're already recommending to your clients, but now at Wholesale Prices and earn a 5% Affiliate Rewards Commission on every purchase your clients make . . . literally make money in your sleep! Welcome To EverFit!

How Does it Work? Easy. Social Share with Friends, Family, & Clients . . . Done. Invite your friends and family to the EverFit Network two ways . . . (1) via the Share Icon located on your profile page . . . (2) and/or via your “Share Link” in your “Settings”. Post or email your link to the world if you want! Once the user clicks your “Share Link” and creates a FREE account, you're done! Easy Peasy! Anytime time your folks buy in the EverFit Shop, you automatically earn a 5% Reward and we square up with you at the end of every month. How big can you build your EverFit Network!?

### Example 4

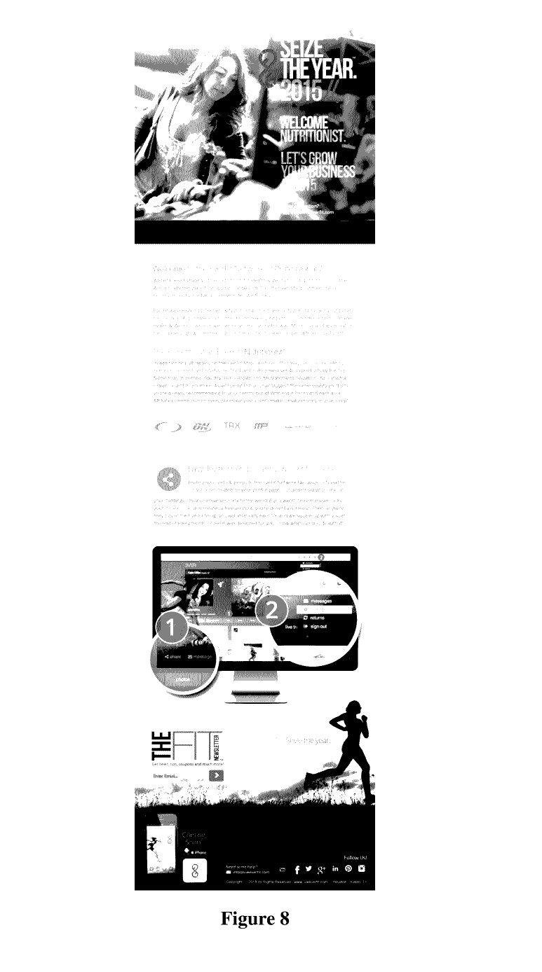

### Nutritionist Sign-Up Auto-Responder (FIG. 8)

Welcome To The EverFit Network of Professionals!

We're stoked to have you! Your passion for Health & Wellness is inspiring to us all! The World is a better place having your compassion for others and helping them to live a healthy, more fulfilled and confident life. We thank you.

EverFit was created by Trainers & Nutritionists, for Trainers, Nutritionists, and your potential clientele. A “positive” environment to increase your personal clientele and encourage Health & Wellness while inspiring one another along the way. Much love and appreciation for helping us grow something “good” for all of us to learn and grow from. Live Everfit!

The Benefits of the EverFit “Nutritionist”. In addition to putting you on the EverFit Map, EverFit has a built in a Rewards Program you can leverage to put a little something in your pocket! The EverFit Shop has over 4000 products by the Top Name Brands in their industry: TRX, Gaspari, On, MusclePharm, Scivation, NES, eSutra Organics, and much more! As an EverFit Pro you can suggest the same quality products you're already recommending to your clients, but now at Wholesale Prices and earn a 5% Affiliate Rewards Commission on every purchase your clients make . . . literally make money in your sleep! Welcome To EverFit!

How Does it work? Easy. Social Share with Friends, Family, & Clients . . . Done. Invite your friends and family to the EverFit Network two ways . . . (1) via the Share Icon located on your profile page . . . (2) and/or via your “Share Link” in your “Settings”. Post or email your link to the world if you want! Once the user clicks your “Share Link” and creates a FREE account, you're done! Easy Peasy! Anytime time your folks buy in the EverFit Shop, you automatically earn a 5% Reward and we square up with you at the end of every month. How big can you build your EverFit Network!?

### Example 5

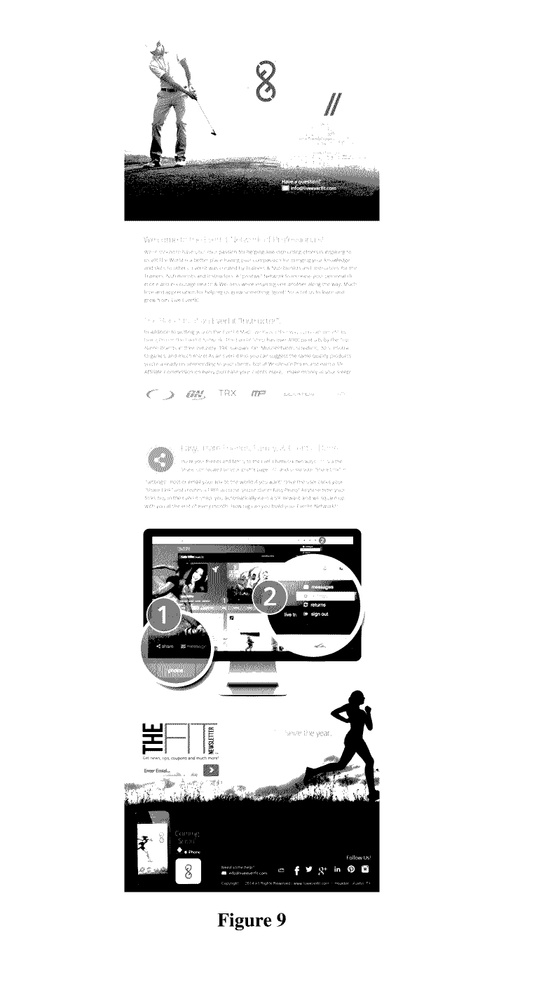

### Instructor Sign-Up Auto-Responder (FIG. 9)

Welcome To The EverFit Network of Professionals!

We're stoked to have you! Your passion for helping and instructing others is inspiring to us all! The World is a better place having your compassion for bringing your knowledge and skills to others. EverFit was created by Trainers & Nutritionists and Instructors, for the Trainers, Nutritionists and Instructors. A “positive” Network to increase your personal clientele and encourage Health & Wellness while inspiring one another along the way. Much love and appreciation for helping us grow something “good” for all of us to learn and grow from. Live Everfit!

The Benefits of the EverFit “Instructor”. In addition to putting you on the EverFit Map, EverFit has a built in a Rewards Program you can leverage to put a little something in your pocket! The EverFit Shop has over 4000 products by the Top Name Brands in their industry: TRX, Gaspari, On, MusclePharm, Scivation, NES, eSutra Organics, and much more! As an EverFit Pro you can suggest the same quality products you're already recommending to your clients, but now at Wholesale Prices and earn a 5% Affiliate Rewards Commission on every purchase your clients make . . . literally make money in your sleep! Welcome To EverFit!

How Does It Work? Easy. Social Share with Friends, Family, & Clients . . . Done. Invite your friends and family to the EverFit Network two ways . . . (1) via the Share Icon located on your profile page . . . (2) and/or via your “Share Link” in your “Settings”. Post or email your link to the world if you want! Once the user clicks your “Share Link” and creates a FREE account, you're done! Easy Peasy! Anytime time your folks buy in the EverFit Shop, you automatically earn a 5% Reward and we square up with you at the end of every month. How big can you build your EverFit Network!?

### Example 6

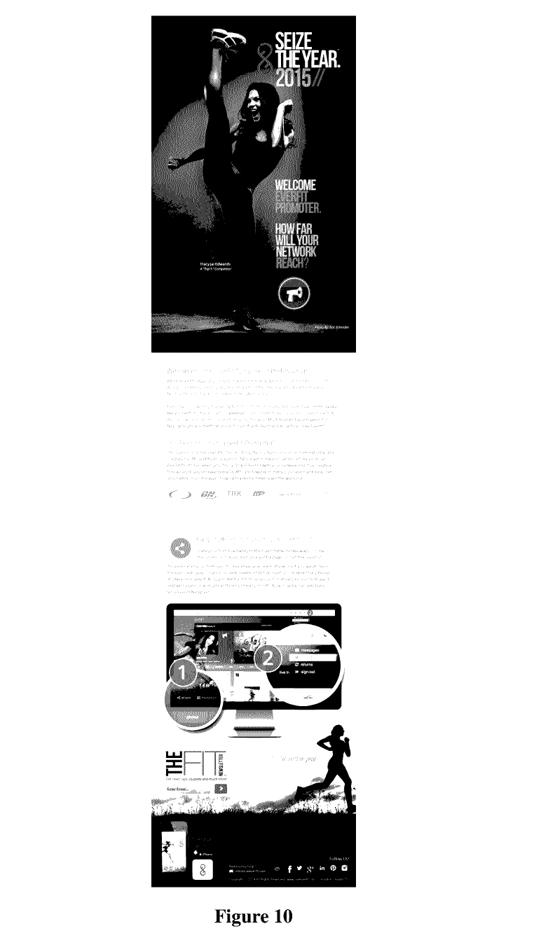

### Promoter Sign-Up Auto-Responder (FIG. 10)

Welcome To The EverFit Network of Professionals!

We're stoked to have you! Your passion for Health & Wellness is inspiring to us all! The World is a better place having your compassion for others and helping them live a healthy, more fulfilled and confident life. We thank you.

EverFit was created by Trainers & Nutritionists, for Trainers, Nutritionists and Enthusiasts like yourself! To give you a “positive” environment to be social and encourage Health & Wellness while inspiring one another along the way. Much love and appreciation for helping us grow something “good” for all of us to learn and grow from. Live Everfit!

The Benefits of the EverFit “Promoter”. The EverFit Shop has over 4000 products by the Top Name Brands in their industry: TRX, Gaspari, On, MusclePharm, Scivation, NES, eSutra Organics, and much more! As an EverFit Promoter, when you “Social Share” EverFit with your network and they create a free account, you're rewarded a 5% Affiliate Reward on every purchase made by a User you invited, our little way of saying thanks for helping get the word out!

How Does it Work? Easy. Social Share with Friends, Family, & Clients . . . Done. Invite your friends and family to the EverFit Network two ways . . . (1) via the Share Icon located on your profile page . . . (2) and/or via your “Share Link” in your “Settings”. Post or email your link to the world if you want! Once the user clicks your “Share Link” and creates a FREE account, you're done! Easy Peasy! Anytime time your folks buy in the EverFit Shop, you automatically earn a 5% Reward and we square up with you at the end of every month. How big can you build your EverFit Network!?

All of the compositions and methods disclosed and claimed herein can be made and executed without undue experimentation in light of the present disclosure. While the compositions and methods of this disclosure have been described in terms of preferred embodiments, it will be apparent to those of skill in the art that variations may be applied to the compositions and methods and in the steps or in the sequence of steps of the methods described herein without departing from the concept, spirit and scope of the disclosure. More specifically, it will be apparent that certain agents which are related may be substituted for the agents described herein while the same or similar results would be achieved. All such similar substitutes and modifications apparent to those skilled in the art are deemed to be within the spirit, scope and concept of the disclosure as defined by the appended claims.

### REFERENCES

Ace Survey, 2005.
International Health, Racquet, and Sportsclub Trend Report.
IBIS World, 2014.
BIA/Kelsey.
Statisticbrain.com.

What is claimed is:

1. A member database comprising users comprising more than one selected from the group consisting of trainers, instructors, nutritionists, gyms and promotors wherein each member has a profile and is capable of interacting with other members.

2. The member database of claim 1 wherein there is a section for clients.

3. The member database of claim 2 wherein there is a contact section.

4. The member database of claim 2 wherein there is a client section.

5. The member database of claim 2 wherein there is a client groups section.

6. The member database of claim 2 wherein there is a trainer requests section.

7. The member database of claim 1 wherein there is a section for trainers.

8. The member database of claim 7 wherein there is a tasks section.

9. The member database of claim 7 wherein there is a workouts section.

10. The member database of claim 7 wherein there is a calendar section.

11. The member database of claim 7 wherein there is a messages section.

12. The member database of claim 7 wherein there is a files section.

13. The member database of claim 7 wherein there is a reports section.

14. The member database of claim 7 wherein there is a settings section.

15. The member database of claim 7 wherein there is a guided tour section.

16. The member database of claim 7 wherein there is a frequently asked questions section.

17. The member database of claim 7 wherein there is a contact section.

18. A system of a digital database comprising
the ability for users to search for at least one selected from the group consisting of products and services; and
receive at least one selected from products and services.

19. A method for providing information to users of a health and fitness social networking system, the method comprising:
maintaining a profile for one or more users;
allowing searching of the profile;
allowing communication between one or more users;
allowing the receipt of one or more communications from one or more users by one or more users; and
allowing one or more users to provide at least one selected from fitness training and nutrition planning for one or more users for a fee; wherein the system receives a portion of the fee.

20. The method for providing information to users of a health and fitness social networking system of claim 20 further comprising recording of information regarding one or more users by one or more users.
